(19) United States
(12) Patent Application Publication
(10) Pub. No.: US 2012/0041088 A1
(43) Pub. Date: Feb. 16, 2012

(54) FOAMING ADDITIVE FOR PRODUCING POLYURETHANE FOAM, AND METHOD FOR PRODUCING RIGID POLYURETHANE FOAM BY USING IT

(76) Inventors: Masaki Ishida, Yamaguchi (JP); Yutaka Tamano, Yamaguchi (JP)

(21) Appl. No.: 13/265,958

(22) PCT Filed: Apr. 23, 2010
(86) PCT No.: PCT/JP2010/057287

§ 371 Date: Oct. 24, 2011

(30) Foreign Application Priority Data
Apr. 24, 2009 (JP) 2009-106225
Jul. 22, 2009 (JP) 2009-171447
Aug. 7, 2009 (JP) 2009-184686

(51) Int. Cl. C08J 9/08; C09K 3/00

(52) U.S. Cl. 521/129; 516/15; 521/128

(57) ABSTRACT

To provide a foaming additive for producing a polyurethane foam, which is capable of solving a problem of deterioration of moldability due to deterioration of the initial foaming property of a foam, and a method for producing a rigid polyurethane foam by using it.

A foaming additive for producing a polyurethane foam, is used which comprises a salt of carbon dioxide with an amine compound of one or more types selected from the group consisting of an amine compound (I) represented by the following formula (1):

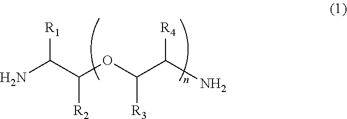

wherein each of R₁ to R₄ which are independent of one another, is a hydrogen atom or a methyl group, and n is a number of at least 1, an amine compound (II) represented by the following formula (2):

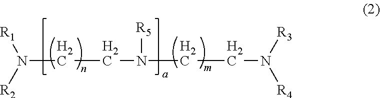

wherein each of R₁ to R₄ which are independent of one another, is a hydrogen atom or a C₁₋₃ alkyl group, R₅ is a hydrogen atom, a C₁₋₃ alkyl group, a C₁₋₃ aminoalkyl group, a C₂₋₄ N-methylaminoalkyl group or a C₃₋₅ N,N-dimethylaminoalkyl group, or R₅ may be optionally bonded to R₁, R₂, R₃ or R₄ to form a cyclic compound having a piperazine structure, provided that at least one of R₁ to R₅ is a hydrogen atom, and all of R₁ to R₅ are not hydrogen atoms, each of n and m which are independent of each other, is an integer of from 1 to 5, and a is an integer of from 1 to 6, an amine compound (III) represented by the following formula (3):

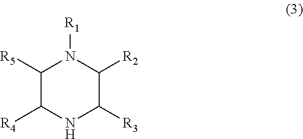

wherein R₁ is a C₁₋₄ alkyl group, and each of R₂ to R₅ which are independent of one another, is a hydrogen atom or a methyl group, an amine compound (IV) represented by the following formula (4):

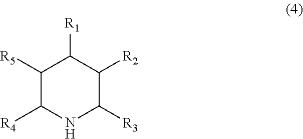

wherein R₁ is a C₁₋₄ alkyl group, and each of R₂ to R₅ which are independent of one another, is a hydrogen atom or a methyl group, and an amine compound (V) represented by the following formula (5):

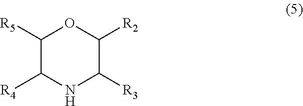

wherein each of R₂ to R₅ which are independent of one another, is a hydrogen atom or a methyl group.

### TECHNICAL FIELD

The present invention relates to a foaming additive for producing a polyurethane foam, which comprises a salt of carbon dioxide with a specific amine compound, and a method for producing a rigid polyurethane foam excellent in foaming property and moldability, by using it.

Further, the present invention relates to a method for producing a rigid polyurethane foam, whereby the initial foaming property can be improved even without using a heavy metal catalyst such as a lead compound or a tin compound.

### BACKGROUND ART

Polyurethane foams are excellent in cushion properties, impact absorbing performance, heat insulating properties and self adhesion, etc., and they are widely used for furnitures, automobile components, electric refrigerators, building materials, etc.

In the production of a rigid polyurethane foam to be used as a heat-insulating material, an organic chlorofluorocarbon compound has been used as a foaming agent in order to maintain the heat-insulating performance. However, in recent years, there has been a movement to inhibit its use with a view to protecting the global environment.

Specifically, a method for producing a rigid polyurethane foam has been adopted wherein hydrofluorocarbons (HFC) having a low global warming potential, or hydrofluorocarbons (HFC), hydrocarbons (HC) and carbon dioxide to be formed by a reaction of an isocyanate with water, are utilized as a foaming agent, without using, as a foaming agent, chlorofluorocarbons (CFC) or hydrochlorofluorocarbons (HCFC) having a high global warming potential (e.g. Patent Document 1).

However, a global warming problem has been seriously pointed out, and there has been a increasing demand for a method for producing a rigid polyurethane foam wherein without using organic compounds such as hydrofluorocarbons or hydrocarbons at all as a foaming agent, only carbon dioxide having a further lower warming potential is used as a foaming agent.

As a method for producing a rigid polyurethane foam using only carbon dioxide as a foaming agent, it is common to use, for example, only water as a foaming agent thereby to utilize carbon dioxide formed by a reaction of the water with a polyisocyanate compound (e.g. Patent Document 2).

However, if only water is used as a foaming agent, there is a problem that bonding failure is likely to occur between the foam and a face material due to an increase of urea bonds by the reaction of water with an isocyanate, and further a problem has been pointed out such that the foam tends to be highly densified.

Further, a method of using carbon dioxide in a subcritical fluid, supercritical fluid or liquid state as a foaming agent (i.e. liquefied carbon dioxide is directly added to the formulation) has been proposed (e.g. Patent Document 3).

The method disclosed in Patent Document 3 is suitable for spray molding, but bonding failure in a low temperature atmosphere or a problem from the viewpoint of an apparatus due to utilization of liquid carbon dioxide has been pointed out.

Further, a method of using an adduct of a primary or secondary amine compound and carbon dioxide, as a foaming agent, has been proposed (e.g. Patent Document 4).

Further, a method of using a salt of carbon dioxide with an amine, as a catalyst, has been known (e.g. Patent Document 5), although this is not a method for producing a rigid polyurethane foam using only carbon dioxide as a foaming agent.

However, the reaction product of carbon dioxide with an amine as disclosed in Patent Document 4 or 5 has a low effect as a foaming agent, whereby there is a problem such that the foam tends to be highly densified, or in a spray molding, the molding property tends to deteriorate, since the initial foaming property is not sufficient.

On the other hand, in a spray type rigid polyurethane foam, a polyol and a polyisocyanate are reacted in the presence of a catalyst, a foaming agent and, as the case requires, assisting agents such as a foam stabilizer, a flame retardant, etc., for foam molding, but from a viewpoint of a molding problem, it is necessary to facilitate the foaming reactivity. That is, in the case of the spray type rigid polyurethane formulation, the reactivity is adjusted so that one having a polyol premix and a polyisocyanate mixed and stirred, is sprayed to a face material to let it instantaneously foam, whereupon the foam will be rapidly gelled and solidified. Usually, in the case of such a spray formulation, the initial foaming property (so-called cream time) is at most 3 seconds, and the gelling time is about 10 seconds.

Heretofore, in order to increase the reactivity, together with an amine-type catalyst, a heavy metal catalyst such as lead 2-ethylhexanoate or dibutyltin dilaurate (hereinafter sometimes referred to as DBTDL) has been used. However, with respect to a lead compound, a tin compound, etc., due to their toxicity an adverse effect to human bodies or to the environment has been worried, and there is a movement for restricting their use. However, if the amount of the amine type catalyst is increased in an attempt to maintain the reactivity without using a heavy metal catalyst such as lead 2-ethylhexanoate or DBTDL, eye irritation or deterioration of the operation environment by e.g. an odor is likely to be brought about due to vaporization or scattering of the amine type catalyst during the spray operation.

As a method to prevent such an eye rainbow phenomenon by an amine catalyst (a phenomenon such that the amine catalyst in the foam volatilizes and attaches to a human eye to lower the visibility), a method of using a reactive amine catalyst having an active hydrogen group in its molecule, has been proposed (e.g. Patent Document 6). Further, a method of using a bismuth compound instead of a lead compound has been proposed (e.g. Patent Document 7).

However, a reactive amine catalyst or a bismuth compound has no adequate initial foaming property, whereby there is a problem such that the moldability deteriorates.

Various studies have been made to solve these problems, but a method for adequate solution has not been found.

### PRIOR ART DOCUMENTS

### Patent Documents

Patent Document 1: JP-A-2003-89714

Patent Document 2: JP-A-2006-307192

Patent Document 3: JP-A-2002-47325

Patent Document 4: JP-A-2001-524995

Patent Document 5: JP-A-2000-239339

Patent Document 6: JP-A-2009-40961

Patent Document 7: JP-A-2005-307145

### DISCLOSURE OF INVENTION

### Technical Problem

The present invention has been made in view of the above background art, and its first object is to provide a foaming additive for producing a polyurethane foam, o which is capable of solving a problem of deterioration of moldability due to deterioration of the initial foaming property of a foam, and a method for producing a rigid polyurethane foam by using it.

Further, a second object of the present invention is to provide a method for producing a rigid polyurethane foam, which is capable of accomplishing an improvement of the initial foaming property and an improvement of the operation efficiency, while suppressing an increase of the amount of an amine catalyst without using a heavy metal catalyst containing a lead compound, a tin compound, etc.

### Solution to Problem

The present inventors have conducted an extensive study to solve such problems and as a result, have found it possible to solve such problems by using a specific catalyst and a foaming additive being a salt of carbon dioxide with a specific amine compound, for the production of a rigid polyurethane foam. Thus, the present invention has been accomplished.

That is, the present invention provides a foaming additive for producing a polyurethane foam, as shown below, and a method for producing a rigid polyurethane foam by using it.
[1] A foaming additive for producing a polyurethane foam, which comprises a salt of carbon dioxide with an amine compound of one or more types selected from the group consisting of an amine compound (I) represented by the following formula (1):

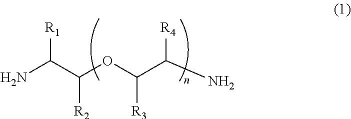

wherein each of R₁ to R₄ which are independent of one another, is a hydrogen atom or a methyl group, and n is a number of at least 1, an amine compound (II) represented by the following formula (2):

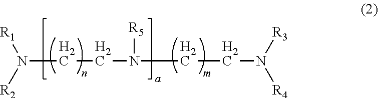

wherein each of R₁ to R₄ which are independent of one another, is a hydrogen atom or a C₁₋₃ alkyl group, R₅ is a hydrogen atom, a C₁₋₃ alkyl group, a C₁₋₃ aminoalkyl group, a C₂₋₄ N-methylaminoalkyl group or a C₃₋₅ N,N-dimethylaminoalkyl group, or R₅ may be optionally bonded to R₁, R₂, R₃ or R₄ to form a cyclic compound having a piperazine structure, provided that at least one of R₁ to R₅ is a hydrogen atom, and all of R₁ to R₅ are not hydrogen atoms, each of n and m which are independent of each other, is an o integer of from 1 to 5, and a is an integer of from 1 to 6, an amine compound (III) represented by the following formula (3):

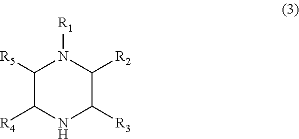

wherein R₁ is a C₁₋₄ alkyl group, and each of R₂ to R₅ which are independent of one another, is a hydrogen atom or a methyl group, an amine compound (IV) represented by the following formula (4):

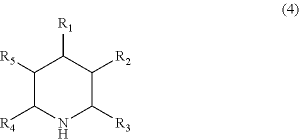

wherein R₁ is a C₁₋₄ alkyl group, and each of R₂ to R₅ which are independent of one another, is a hydrogen atom or a methyl group, and an amine compound (V) represented by the following formula (5):

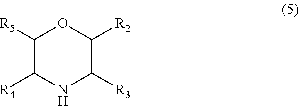

wherein each of R₂ to R₅ which are independent of one another, is a hydrogen atom or a methyl group.
[2] The foaming additive according to the above [1], wherein the amine compound (I) is selected from the group consisting of a polyoxypropylenediamine and a polyoxyethylenediamine, having a molecular weight of at least 104.
[3] The foaming additive according to the above [1], wherein the amine compound (II) is an N-alkylated derivative of an amine compound selected from the group consisting of diethylenetriamine, dipropylenetriamine, dihexamethylenetriamine, triethylenetetramine, tripropylenetetramine, tetraethylenepentamine, pentaethylenehexamine, N-aminoethylpiperazine, N-2-(2′-aminoethyl)aminoethylpiperazine, N,N′-bis(2-aminoethyl)piperazine, N-2-(2′(2″-aminoethyl)aminoethyl)aminoethylpiperazine, N-2-(2′-aminoethyl)aminoethyl-N′-aminoethylpiperazine, N,N′-bis(3-aminopropyl)piperazine, tris(2-aminoethyl)amine, tris (3-aminopropyl)amine and N,N-bis(2-aminoethyl)diethylenetriamine.
[4] The foaming additive according to the above [1], wherein the amine compounds (III) to (V) are amine compounds selected from the group consisting of 1-methylpiperazine, 1-ethylpiperazine, 1-propylpiperazine, 1-isopropylpiperazine, 1-butylpiperazine, 1,2-dimethylpiperazine, 1,3-dimethylpiperazine, morpholine, 2-methylmorpholine, 3-methylmorpholine, piperidine, 2-methylpiperidine, 3-methylpiperidine and 4-methylpiperidine.
[5] A foaming additive for producing a polyurethane foam, which comprises the salt of carbon dioxide with an amine as defined in any one of the above [1] to [4], dissolved in a solvent.
[6] The foaming additive according to the above [5], wherein the solvent is water or a mixture of water with an organic solvent.
[7] A method for producing a rigid polyurethane foam, which comprises reacting a polyol with a polyisocyanate in the presence of a catalyst and a foaming agent, wherein the catalyst is a catalyst of one or more types selected from the group consisting of a tertiary amine, a quaternary ammonium salt and a carboxylic acid metal salt (provided that salts of lead, tin and mercury are excluded), and a part or whole of the foaming agent is the foaming additive as defined in any one of the above [1] to [6].
[8] A method for producing a spray type rigid polyurethane foam, which comprises reacting a polyol with a polyisocyanate in the presence of a catalyst and a foaming agent, wherein the catalyst is a catalyst of one or more types selected from the group consisting of a tertiary amine, a quaternary ammonium salt and a carboxylic acid metal salt (provided that salts of lead, tin and mercury are excluded), and a part or whole of the foaming agent is the foaming additive as defined in any one of the above [1] to [6].
[9] The method according to the above [7] or [8], wherein the tertiary amine is selected from the group consisting of N,N-dimethylaminoethanol, N,N,N′-trimethylaminoethylethanolamine, 2-(2-dimethylaminoethoxy)ethanol, N,N,N′-trimethyl-N′-hydroxyethylbisaminoethyl ether, N-(3-dimethylaminopropyl)-N,N-diisopropanolamine, N-(2-hydroxyethyl)-N′-methylpiperazine, N,N-dimethylaminohexanol and 5-dimethylamino-3-methyl-1-pentanol.
[10] The method according to the above [7] to [9], wherein the quaternary ammonium salt is selected from the group consisting of tetramethylammonium acetate, tetramethylammonium formate, tetraethylammonium acetate, tetraethylammonium formate and tetramethylammonium 2-ethylhexanoate.
[11] The method according to the above [7] to [10], wherein the carboxylic acid metal salt is selected from the group consisting of a bismuth salt of carboxylic acid, a zinc salt of carboxylic acid and an alkali metal salt of carboxylic acid.
[12] The method according to any one of the above [7] to [11] wherein only the foaming additive as defined in any one of the above [1] to [6] and water, are used as the foaming agent.

### Advantageous Effects of Invention

The foaming additive of the present invention presents a high carbon dioxide gas generation rate and thus acts as a foaming agent having a high foaming efficiency. Further, the foaming additive of the present invention has a low odor and a low volatility and thus improves the operation environment.

When the foaming additive of the present invention is used as a part or whole of the foaming agent at the time of producing a rigid polyurethane foam, it is possible to expedite the foaming initiation time without using a heavy metal catalyst such as a lead compound or a tin compound as the catalyst and without increasing the amount of an amine catalyst used. Therefore, the foaming additive of the present invention is particularly suitably used for the production of a spray type rigid polyurethane foam.

Thus, the present invention is industrially very useful, since it is thereby possible to produce a spray type rigid polyurethane foam having a foaming initiation time expedited without polluting the environment.

### DESCRIPTION OF EMBODIMENTS

Now, the present invention will be described in detail.

The foaming additive for producing a polyurethane foam of the present invention is characterized in that it comprises a salt of carbon dioxide with an amine compound of one or more types selected from the group consisting of the above-mentioned amine compounds (I), (II), (III), (IV) and (V).

In the present invention, the above-mentioned salt of carbon dioxide with the amine compound may be dissolved in a solvent. In the solvent, the salt of carbon dioxide with the amine compound is present in the form of an amine carbonate.

As the amine compound (I) represented by the above formula (1), a polyoxypropylenediamine or polyoxyethylenediamine, having a molecular weight of at least 104, may be suitably used, although it is not particularly limited. The molecular weight is more preferably within a range of from 150 to 500. Further, in the above formula (1), n is usually a number within a range of from 1 to 35, preferably a number within a range of from 1 to 9. If the molecular weight is too small, the carbon dioxide gas generation rate tends to be low, and if the molecular weight is too large, the amount of addition of carbon dioxide tends to be small, such being undesirable.

The above salt of carbon dioxide with the amine compound (I) has such a characteristic that the carbon dioxide gas generation rate by thermal decomposition is high.

The above amine compound (I) can be produced by a conventional method. For example, it can be produced by reacting a polypropylene glycol or a polyethylene glycol having a corresponding molecular weight with ammonia at a high temperature under a high pressure.

The above amine compound (I) may specifically be commercially available polyoxypropylenediamines, such as JEFFAMINE D-230 [in the above formula (I), R₁ and R₃ are methyl groups, R₂ and R₄ are hydrogen atoms, and n is about 3.7; the molecular weight is about 230; CAS No. 9046-10-0] and JEFFAMINE D-400 [in the above formula (1), R₁ and R₃ are methyl groups, R₂ and R₄ are hydrogen atoms, and n is about 7.1; the molecular weight is about 430; and CAS No. 9046-10-0] (manufactured by Huntsman). Further, as the polyoxyethylenediamine, an aminated derivative of a polyethylene glycol (such as tetraethylene glycol) may specifically be exemplified.

Further, the amine compound (II) represented by the above formula (2) is not particularly limited, but may, for example, be an N-alkylated derivative of e.g. diethylenetriamine, dipropylenetriamine, dihexamethylenetriamine, triethylenetetramine, tripropylenetetramine, tetraethylenepentamine, pentaethylenehexamine, N-aminoethylpiperazine, N-2-(2′-aminoethyl)aminoethylpiperazine, N,N′-bis(2-aminoethyl)piperazine, N-2(2′-(2″-aminoethyl)aminoethyl)aminoethylpiperazine, N-2-(2′-aminoethyl)aminoethy-N′-aminoethylpiperazine, N,N′-bis(3-aminopropyl)piperazine, tris(2-aminoethyl)amine, tris(3-aminopropyl)amine or N,N-bis(2-aminoethyl)diethylenetriamine.

Here, in the above formula (2), at least one of substituents R₁ to R₅ is a hydrogen atom, and all of R₁ to R₅ are not hydrogen atoms. Further, in substituents R₁ to R₅, the alkyl group is preferably a methyl group.

In such an N-alkylated derivative, the alkylated proportion of active hydrogen atoms bonded to a nitrogen atom in the precursor amine compound is preferably within a range of from 20% to 80%.

The above amine compound (II) can easily be obtained by partially N-alkylating a linear, branched or cyclic polyalkylene polyamine by an alkylating agent such as a monoalcohol, an aldehyde or an alkyl halide. As the alkylating agent, formaldehyde is preferably used.

Further, the amine compounds (III) to (V) represented by the above formulae (3) to (5) are cyclic secondary amines, and they are not particularly limited so long as they belong to any one of the above formulae (3) to (5). Such amine compounds may, for example, be 1-methylpiperazine, 1-ethylpiperazine, 1-propylpiperazine, 1-isopropylpiperazine, 1-butylpiperazine, 1,2-dimethylpiperazine, 1,3-dimethylpiperazine, morpholine, 2-methylmorpholine, 3-methylmorpholine, piperidine, 2-methylpiperidine, 3-methylpiperidine, 4-methylpiperidine, etc. Among them, 1-methylpiperazine, 1-ethylpiperazine, 1,2-dimethylpiperazine, 1,3-dimethylpiperazine, morpholine, 2-methylmorpholine, piperidine or 4-methylpiperidine is preferred.

The salt of carbon dioxide with the above-described amine compound can easily be produced, for example, by blowing carbon dioxide gas into a mixed solution having the amine compound and a solvent mixed at room temperature, whereupon a reaction takes place with heat generation. Here, the temperature of the mixed solution during the reaction is adjusted preferably not to exceed 50° C., more preferably to be at most 40° C. The added amount of carbon dioxide is not particularly limited, but it is preferably within a range of from 0.01 to 0.5 time by mole, per 1 mol of an amino group in the above-described amine compound (I) to (V). Even if carbon dioxide is not completely added to the amino group, a function as a foaming agent can be obtained, but it is preferred to supply carbon dioxide gas until carbon dioxide is completely added to the amino group.

The salt of carbon dioxide with the amine compound is usually solid, and therefore, it is preferably made to be a liquid product as dissolved in a solvent in view of a problem during the production or use. The solvent is not particularly limited, but may, for example, be water or an organic solvent. As the organic solvent, a glycol such as ethylene glycol, diethylene glycol, dipropylene glycol or butanediol, or further, a polyol for producing a polyurethane, as described hereinafter, is preferred. Among them, water or a mixture of water and a glycol is further preferred. The amount of the solvent is not particularly limited, but it is usually from 0.2 to 4 times, per 1 of the amine carbonate. If the amount of the solvent is too small, the solution is likely to have a high viscosity.

The method for producing a rigid polyurethane foam of the present invention is a method for producing a rigid polyurethane foam, which comprises reacting a polyol with a polyisocyanate in the presence of a catalyst and a foaming agent, wherein the catalyst is a catalyst of one or more types selected from the group consisting of a tertiary amine, a quaternary ammonium salt and a carboxylic acid metal salt (provided that salts of lead, tin and mercury are excluded), and a part or whole of the foaming agent is the above-described foaming additive of the present invention.

Further, the method for producing a spray type rigid polyurethane foam of the present invention is a method for producing a spray type rigid polyurethane foam, which comprises reacting a polyol with a polyisocyanate in the presence of a catalyst and a foaming agent, wherein the catalyst is a catalyst of one or more types selected from the group consisting of a tertiary amine, a quaternary ammonium salt and a carboxylic acid metal salt (provided that salts of lead, tin and mercury are excluded), and a part or whole of the foaming agent is the above-described foaming additive of the present invention.

Here, the spray type rigid polyurethane foam is usually a rigid polyurethane foam which is produced by instantaneously stirring, mixing and foaming, by a spraying method, a polyisocyanate and a polyol containing a foaming agent, catalyst and other assisting agents. The spray type rigid polyurethane foam is capable of foaming in place, is light in weight and has excellent heat-insulating property, and thus it is widely used as a heat-insulating material in fields where thermal insulation or cold insulation is required, such as heat insulation of a freezer or a refrigerator, heat insulation of various tanks such as a LPG ship, a plant, etc., bathtub insulation, insulation of ceiling, wall, floor, etc. in housing, etc.

In the method of the present invention, the amount of the foaming additive of the present invention to be used is usually within a range of from 0.1 to 20 parts by weight, preferably within a range of from 0.5 to 10 parts by weight, as an amine carbonate, per 100 parts by weight of the polyol to be used.

The polyol to be used for the method of the present invention is not particularly limited, and a conventional compound may be used. For example, a polyether polyol, a polyester polyol, a polymer polyol, a phenol polyol, or further, a flame retardant polyol such as a phosphorus-containing polyol or a halogen-containing polyol, having at least two reactive hydroxy groups and having a hydroxy value within a range of from 50 to 1,000 mgKOH/g, may, for example, be mentioned.

Here, as the polyether polyol, a compound having an alkylene oxide added to an active hydrogen compound may, for example, be mentioned. The active hydrogen compound may, for example, be a polyhydric alcohol (such as ethylene glycol, propylene glycol, 1,4-butanediol, 1,6-hexanediol, diethylene glycol, triethylene glycol, dipropylene glycol, neopentyl glycol, glycerol, trimethylolpropane, pentaerythritol, methyl glucoside, sorbitol, sucrose, etc.), a bisphenol (such as bisphenol A, bisphenol S, bisphenol F, a low condensate of phenol and formaldehyde, etc.), an aliphatic amine (such as propylenediamine, hexamethylenediamine, ethylenediamine, diethylenetriamine, triethylenetetramine, pentamethylenehexamine, ethanolamine, diethanolamine, triethanolamine, aminoethylethanolamine, etc.), an aromatic amine (such as aniline, phenylenediamine, xylylenediamine, methylenedianiline, diphenyl ether diamine, etc.), an alicyclic amine (such as isophoronediamine, cyclohexylenediamine, etc.), a heterocyclic amine (such as aminoethylpiperazine), or a mannich polyol (such as a compound obtained by a mannich reaction of the above-mentioned polyhydric phenol, the above-mentioned aliphatic amine and formaldehyde). These polyols may be used alone, or two or more of them may be used in combination.

The alkylene oxide to be added to the above active hydrogen compound may, for example, be ethylene oxide, propylene oxide, butylene oxide or a combination of two or more of them. Among them, preferred is ethylene oxide, propylene oxide or a combination thereof.

Further, the polyester polyol may, for example, be a condensed polyester polyol obtainable by reacting the above-mentioned polyhydric alcohol and a polybasic acid (such as phthalic acid, succinic acid, adipic acid, sebacic acid, maleic acid, dimer acid, trimellitic acid, etc.), or a polylactone polyol obtained by ring-opening polymerization of a lactone such as ε-caprolactone.

Further, the polymer polyol may, for example, be a polymer polyol obtained by reacting the above-mentioned polyether polyol and an ethylenically unsaturated monomer (such as butadiene, acrylonitrile, styrene, etc.) in the presence of a radical polymerization catalyst.

Among these polyols, in the method of the present invention, an aliphatic amine type or aromatic amine type polyether polyol, a mannich polyol or a phthalic acid type polyester polyol is suitably used. The phthalic acid type polyester polyol may, for example, be a polyol to be produced by a conventional method by using a phthalic acid such as orthophthalic acid, isophthalic acid or phthalic anhydride, and one or more types of a compound having at least two hydroxy groups, or a phthalic acid type recovered polyester polyol obtainable by decomposing a phthalic acid type polyester molded product such as a polyethylene terephthalate.

The polyisocyanate to be used for the method of the present invention is not particularly limited, and a conventional compound may be used. For example, an aromatic polyisocyanate, an aliphatic polyisocyanate such as isophorone diisocyanate, 1,6-hexamethylene diisocyanate or 4,4′-dicyclohexylmethane diisocyanate, an aromatic ring type polyisocyanate such as xylylene diisocyanate or tetramethylxylylene diisocyanate, or a modified product thereof (such as carbodiimide-modified, allophanate-modified, urea-modified, burette-modified, isocyanurate-modified, oxazolidone-modified, etc.), an isocyanate group-terminal prepolymer, etc. may be mentioned.

Here, the aromatic polyisocyanate may, for example, be 2,4- or 2,6-toluene diisocyanate (TDI), crude TDI, diphenylmethane 2,4′- or 4,4′-diisocyanate (MDI), or polymethylenepolyphenyl isocyanate (crude MDI).

In the method of the present invention, these polyisocyanates may be used alone, or in combination as suitably mixed.

Among these polyisocyanates, in the method for producing a rigid polyurethane foam, it is preferred to employ 2,4- or 2,6-toluene diisocyanate (TDI), crude TDI, diphenylmethane 2,4′- or 4,4′-diisocyanate (MDI) or polymethylenepolyphenyl isocyanate (crude MDI). More preferred is polymethylenepolyphenyl isocyanate (crude MDI).

Whereas, in the method for forming a spray type rigid polyurethane foam, it is preferred to employ 4,4′-diisocyanate (MDI), polymethylenepolyphenyl isocyanate (crude MDI) or its modified product.

The amount of such a polyisocyanate is preferably within a range of from 80 to 400 by INDEX of active hydrogen compound (polyol, water or the like) reactive with polyisocyanate (=[isocyanate group]/[active hydrogen group reactive with isocyanate group] (molar ratio)×100), in consideration of the foam strength, completion of the isocyanurate reaction, etc. (hereinafter such INDEX may sometimes be referred to as “isocyanate index”).

The catalyst to be used for the method of the present invention is a conventional tertiary amine, quaternary ammonium salt or carboxylic acid metal salt not containing lead, tin or mercury.

The tertiary amine may, for example, be an amine compound such as triethylenediamine, dimethylcyclohexylamine, N,N,N′,N′-tetramethylethylenediamine, N,N,N′,N″,N″-pentamethyldiethylenetriamine, N,N,N′,N″,N″,N″-hexamethyltriethylenetetramine, bis(dimethylaminoethyl)ether, 1,3,5-tris(N,N-dimethylaminopropyl)hexahydro-S-triazine, N-dimethylaminoethyl-N′-methylpiperazine, N,N,N′,N′-tetramethylhexamethylenediamine, 1,2-dimethylimidazole, N,N-dimethylaminopropylamine or bis(dimethylaminopropyl)amine, or an alkanolamine such as N,N-dimethylaminoethanol, N,N,N′-trimethylaminoethylethanolamine, 2-(2-dimethylaminoethoxy)ethanol, N,N,N′-trimethyl-N′-hydroxyethylbisaminoethyl ether, N-(3-dimethylaminopropyl)-N,N-diisopropanolamine, N-(2-hydroxyethyl)-N′-methylpiperazine, N,N-dimethylaminohexanol or 5-dimethylamino-3-methyl-1-pentanol.

Among them, N,N-dimethylaminoethanol, N,N,N′-trimethylaminoethylethanolamine, 2-(2-dimethylaminoethoxy)ethanol, N,N,N′-trimethyl-N′-hydroxyethylbisaminoethyl ether, N-(3-dimethylaminopropyl)-N,N-diisopropanolamine, N-(2-hydroxyethyl)-N′-methylpiperazine, N,N-dimethylaminohexanol, 5-dimethylamino-3-methyl-1-pentanol, N,N-dimethylaminopropylamine or bis(dimethylaminopropyl)amine, which has in its molecule, a primary or secondary amino group or a hydroxy group reactive with an isocyanate, is more preferred, since an odor or eye irritation is little during spray foaming, and the initial foaming property is also good.

The quaternary ammonium salt may, for example, be a tetraalkylammonium organic acid salt or a hydroxyalkyl type quaternary ammonium organic acid salt, and specifically, it may, for example, be tetramethylammonium acetate, tetramethylammonium formate, tetraethylammonium acetate, tetraethylammonium formate, tetramethylammonium 2-ethylhexanoate, 2-hydroxypropyltrimethylammonium formate or 2-hydroxypropyltrimethylammonium 2-ethylhexanoate.

Among them, tetramethylammonium acetate, tetramethylammonium formate, tetraethylammonium acetate, tetraethylammonium formate or tetramethylammonium 2-ethylhexanoate is preferred, since the isocyanurate activity is high.

The carboxylic acid metal salt is not particularly limited, so long as it is a metal salt other than lead, tin or mercury, but it is preferably a bismuth salt of carboxylic acid, a zinc salt of carboxylic acid or an alkali metal salt of carboxylic acid. Among them, bismuth octanoate, bismuth neodecanoate, zinc octanoate, zinc neodecanoate, zinc naphthenoate, potassium acetate or potassium 2-ethylhexanoate is more preferred, since the activity is high. Further, potassium acetate or potassium 2-ethylhexanoate is particularly preferred, since the isocyanurate activity is high.

Among them, for the method for producing a rigid polyurethane foam, N,N,N′-trimethylaminoethyethanolamine, 2-(2-dimethylaminoethoxy)ethanol or N,N,N′-methyl-N′-hydroxyethylbisaminoethyl ether is preferred, whereby the odor can be reduced, and the foaming initiation time can be facilitated.

Further, for a formulation with an isocyanate index of at least 100, potassium acetate, potassium 2-ethylhexanoate or a quaternary ammonium salt is preferably used, since the isocyanurate activity is high.

The amount of such a catalyst to be used is not particularly limited, but usually, per 100 parts by weight of a polyol, it is preferred to use a tertiary amine within a range of from 0.1 to 10 parts by weight, a quaternary ammonium salt within a range of from 0.1 to 5 parts by weight, or a carboxylic acid metal salt within a range of from 0.1 to 5 parts by weight.

As the foaming agent, in addition to the above-described foaming additive of the present invention, a conventional organic compound or water may, for example, be used, and they may be used in combination. The organic compound may, for example, be a fluorinated compound, and specifically, a hydrofluorocarbon (HFC) such as 1,1,1,3,3-pentafluoropropane (HFC-245fa) or 1,1,1,3,3-pentafluorobutane (HFC-365mfc) is preferred. From the viewpoint of the global warming problem, water is the most preferred foaming agent. The amount of water to be used is not particularly limited, since it is optionally changed depending upon the desired density or the amount of the amine carbonate to be used. However, it is preferred to use, for example, at least 1 part by weight of water per 100 parts by weight of the polyol. More preferably, at least 3 parts by weight of water is used per 100 parts by weight of the polyol.

In the method of the present invention, an assisting agent such as a foam stabilizer or a flame retardant may be used, as the case requires.

As the foam stabilizer, one commonly used in this field may be employed without any particular restriction. For example, a non-ionic surfactant such as an organopolysiloxane/oxyalkylene copolymer or a silicone/glycol copolymer, or a mixture thereof may be mentioned. Its amount to be used is not particularly limited, but is usually within a range of from 0.1 to 10 parts by weight per 100 parts by weight of the polyol.

As the flame retardant, one commonly used in this field may be employed without any particular restriction. For example, a phosphoric acid ester such as tricresyl phosphate, a halogen-containing phosphoric acid ester such as trischloroethyl phosphate or trischloropropyl phosphate, a halogen-containing organic compound such as dibromopropanol, dibromoneopentyl glycol or tetrabromobisphenol A, or an inorganic compound such as antimony oxide, magnesium carbonate, calcium carbonate or aluminum phosphate may be mentioned. Among them, a halogen-containing phosphoric acid ester is preferred, and trischloropropyl phosphate is particularly preferred, since it has good stability and high flame redundancy.

The amount of such a flame retardant to be used is not particularly limited, since it varies depending upon the desired flame retardancy, but in consideration of the balance of the flame redundancy and the foam strength, it is preferably within a range of from 5 to 100 parts by weight, per 100 parts by weight of the polyol. The flame retardancy may be improved as the amount of the flame retardant increases, but if it is excessively added, the foam strength is likely to deteriorate.

Further, if necessary, a viscosity-reducing agent, a crosslinking agent or chain extender, a colorant, an anti-aging agent or other known additives may further be used.

In the method of the present invention, for example, the above-described foaming additive, a catalyst, a foaming agent, etc. may be mixed to form a premix liquid, and two liquids i.e. this premix liquid and a polyisocyanate liquid are mixed and sprayed by means of a spray machine to produce a foam-molded rigid polyurethane foam (spray type rigid polyurethane foam).

The rigid polyurethane foam obtainable by the method of the present invention is one having such foam physical properties that the density is usually within a range of from 10 to 500 kg/m³, preferably within a range of from 20 to 100 kg/m³, the thermal conductivity is usually at most 40 mW/m·K, and the 10% compression strength is usually about 3.0 kg/cm² (in a case where the foam density is about 50 kg/m³).

The rigid polyurethane foam obtainable by the method of the present invention is useful, for example, as a heat-insulating material.

### EXAMPLES

Now, the present invention will be described with reference to Examples and Comparative Examples, but it should be understood that the present invention is by no means restricted to such Examples. Here, “%” in Tables represents weight % unless otherwise specified.

### Examples 1 and 2, and Comparative Examples 1 to 6

<Preparation of Salt (Amine Carbonate) of Carbon Dioxide with Amine Compound>

Into a 500 ml three-necked flask equipped with a stirrer, from 100 to 150 g of an amine compound shown in Table 1, and a suitable amount of pure water or a solvent, were charged and adjusted to a liquid temperature of 20° C. with stirring, and then, while adjusting the temperature so that the liquid temperature did not exceed 40° C., carbon dioxide gas was bubbled into the liquid for about 3 hours from a liquefied carbon dioxide bottle to prepare an aqueous solution of an amine carbonate. The heat generation by the reaction of the amine compound with carbon dioxide was terminated in about 1 hour. The obtained amine carbonate aqueous solutions were designated as 1C-1 to 1C-8, respectively, and about 200 g of each of them was sampled and used for the following analyses and evaluation as a foaming agent for urethane.

The concentrations of components (wt %) in each amine carbonate aqueous solution are shown in Table 1. In Table 1, amine compound 1A and amine compound 1B correspond to the amine compound (I) of the present invention,

TABLE 1

| | | Examples | | Comparative Examples | | | | | |
|---|---|---|---|---|---|---|---|---|---|
| | | 1 | 2 | 1 | 2 | 3 | 4 | 5 | 6 |
| Composition | Amine | 45.5 | — | — | — | — | — | — | — |
| of amine | compound 1A ¹⁾ | | | | | | | | |
| carbonate (%) | Amine | — | 64.8 | — | — | — | — | — | — |
| | compound 1B ²⁾ | | | | | | | | |
| | Amine | — | — | 60.0 | — | — | — | — | — |
| | compound 1C ³⁾ | | | | | | | | |
| | Amine | — | — | — | 21.1 | — | — | — | — |
| | compound 1D ⁴⁾ | | | | | | | | |
| | Amine | — | — | — | — | 21.4 | — | — | — |
| | compound 1E ⁵⁾ | | | | | | | | |
| | Amine | — | — | — | — | — | 64.8 | — | — |
| | compound 1F ⁶⁾ | | | | | | | | |
| | Amine | — | — | — | — | — | — | 45.1 | — |
| | compound 1G ⁷⁾ | | | | | | | | |
| | Amine | — | — | — | — | — | — | — | 45.2 |
| | compound 1H ⁸⁾ | | | | | | | | |
| | Carbon dioxide | 9.0 | 7.4 | 12.0 | 15.6 | 14.1 | 19.0 | 9.8 | 9.6 |
| | water | 45.5 | 27.8 | 28.0 | 63.3 | 64.5 | 16.2 | 45.1 | 45.2 |
| | Solvent ⁹⁾ | — | — | — | — | — | — | — | — |

| | | | | | | | | |
|---|---|---|---|---|---|---|---|---|
| Amine carbonate | 1C-1 | 1C-2 | 1C-3 | 1C-4 | 1C-5 | 1C-6 | 1C-7 | 1C-8 |
| CO₂ gas generation (%) | 83 | 93 | 39 | 32 | 36 | 48 | 29 | 35 |

¹⁾ Polyoxyalkylenediamine (manufactured by Huntsman, tradename: Jeffamine D230)
²⁾ Polyoxyalkylenediamine (manufactured by Huntsman, tradename: Jeffamine D400)
³⁾ Diethanolamine (reagent)
⁴⁾ Ethylenediamine (reagent)
⁵⁾ Diethylenetriamine (reagent)
⁶⁾ N-methylethanoiamine (reagent)
⁷⁾ N,N-dimethylaminopropylamine (reagent)
⁸⁾ 2-(2-Aminoethoxy)ethanol (reagent)
⁹⁾ Ethylene glycol (reagent)

The concentration of carbon dioxide was obtained by subjecting each amine carbonate aqueous solution to a titration analysis by a sodium methoxide solution (0.1N methanol solution). Further, the concentrations of the amine compound, water and the solvent were obtained by calculation from the charged amounts.

### <Carbon Dioxide Gas Generation of Amine Carbonate>

A water-cooling device was mounted to the above-mentioned 500 ml three-necked flask equipped with a stirrer, and the remaining amine carbonate aqueous solution was heated to 80° C. During the temperature rise, generation of carbon dioxide gas was observed, and finally, carbon dioxide gas was generated at 80° C. for 30 minutes. Then, the 500 ml three-necked flask was cooled to room temperature, and the liquid remaining inside was sampled, and the concentration (wt %) of carbon dioxide gas was obtained by the above-mentioned analytical method.

From this result, the carbon dioxide gas generation (80° C.) of each amine carbonate was obtained by calculation and shown in Table 1.

As is evident from Table 1, the amine carbonates (1C-1 to 1C-2) of the present invention has high carbon dioxide gas generation by heat decomposition and thus has a high effect as a foaming agent. On the other hand, amine carbonates (1C-3 to 1C-8) in Comparative Examples have low carbon dioxide gas generation and evidently have a low effect as a foaming gent.

### Examples 3 to 8 and Comparative Examples 7 to 16

### <Production of Rigid Polyurethane Foam>

Polyol 1A, polyol 1B, a foam stabilizer, a flame retardant, catalyst 1A to catalyst 1C, water and an amine carbonate aqueous solution (1C-1 to 1C-8) shown in Table 1, were mixed in a ratio shown in Table 2 to obtain a premix liquid. 60 g of this premix liquid was taken into a 200 ml polyethylene cup, and the temperature was adjusted to 10° C. To this 200 ml polyethylene cup, a polyisocyanate in Table 2 having the temperature adjusted to 10° C. in a separate container was quickly added in such an amount that the isocyanate index became 110. After stirring at 7,000 rpm for 3 seconds by a high speed stirring machine, this mixture was quickly transferred to a 2 L polyethylene cup provided with a stainless steel plate and having the temperature adjusted to 0° C. and subjected to foam molding. At that time, in the 2 L polyethylene cup, the foam reactivity and the bond strength were measured. Further, the moldability and the foam density of the obtained rigid polyurethane foam were evaluated. These results are shown in Table 2.

TABLE 2

| | | Examples | | | | | |
|---|---|---|---|---|---|---|---|
| | | 3 | 4 | 5 | 6 | 7 | 8 |
| Foaming | Polyol 1A ¹⁰⁾ | 50 | 50 | 50 | 50 | 50 | 50 |
| formulation | Polyol 1B ¹¹⁾ | 50 | 50 | 50 | 50 | 50 | 50 |
| (parts by | Foam stabilizer ¹²⁾ | 2 | 2 | 2 | 2 | 2 | 2 |
| weight) | Flame retardant ¹³⁾ | 20 | 20 | 20 | 20 | 20 | 20 |
| | Amine carbonate | 1C-1 | 1C-1 | 1C-1 | 1C-2 | 1C-2 | 1C-1 |
| | (added amount) ¹⁴⁾ | (8.8) | (10.0) | (4.0) | (5.0) | (12.2) | (10.0) |
| | Added amount of water | 0 | 0.45 | 3.20 | 3.61 | 1.62 | 0.45 |
| | (total amount of water) ¹⁵⁾ | (4.0) | (5.0) | (5.0) | (5.0) | (5.0) | (5.0) |
| | Catalyst 1A ¹⁶⁾ | 2.5 | 2.7 | 2.8 | 3.0 | 2.9 | 3.0 |
| | Catalyst 1B ¹⁷⁾ | — | — | — | — | — | — |
| | Catalyst 1C ¹⁸⁾ | 3.0 | 3.0 | 3.0 | 3.0 | 3.0 | 3.0 |
| | Polyisocyanate ¹⁹⁾ | 152 | 169 | 163 | 164 | 167 | 261 |
| Isocyanate Index | | 110 | 110 | 110 | 110 | 110 | 170 |
| Foam reactivity | | | | | | | |
| | Cream time (sec) | 5.0 | 5.1 | 5.3 | 5.0 | 4.7 | 6.5 |
| | Gel time (sec) | 20 | 20 | 20 | 20 | 20 | 28 |
| | Rise time (sec) | 39 | 39 | 38 | 39 | 38 | 45 |

| | | | | | | |
|---|---|---|---|---|---|---|
| Foam density (kg/m³) | 31.5 | 28.6 | 28.9 | 28.6 | 28.1 | 32.5 |
| Moldability | ◯ | ◯ | ◯ | ◯ | ◯ | ◯ |
| Bond strength (kg/cm²) | 1.3 | 1.2 | 1.4 | 1.5 | 1.3 | 1.0 |

| | | Comparative Examples | | | | | | | | | |
|---|---|---|---|---|---|---|---|---|---|---|---|
| | | 7 | 8 | 9 | 10 | 11 | 12 | 13 | 14 | 15 | 16 |
| Foaming | Polyol 1A ¹⁰⁾ | 50 | 50 | 50 | 50 | 50 | 50 | 50 | 50 | 50 | 50 |
| formulation | Polyol 1B ¹¹⁾ | 50 | 50 | 50 | 50 | 50 | 50 | 50 | 50 | 50 | 50 |
| (parts by | Foam stabilizer ¹²⁾ | 2 | 2 | 2 | 2 | 2 | 2 | 2 | 2 | 2 | 2 |
| weight) | Flame retardant ¹³⁾ | 20 | 20 | 20 | 20 | 20 | 20 | 20 | 20 | 20 | 20 |
| | Amine carbonate | — | — | — | 1C-3 | 1C-3 | 1C-4 | 1C-5 | 1C-6 | 1C-7 | 1C-8 |
| | (added amount) ¹⁴⁾ | | | | (7.5) | (7.5) | (5.8) | (6.4) | (5.8) | (9.2) | (9.4) |
| | Added amount of water | 5.0 | 5.0 | 6.0 | 2.90 | 2.90 | 1.35 | 0.88 | 4.0 | 0.86 | 0.75 |
| | (total amount of water) ¹⁵⁾ | | | | (5.0) | (5.0) | (5.0) | (5.0) | (5.0) | (5.0) | (5.0) |
| | Catalyst 1A ¹⁶⁾ | 3.0 | — | — | — | 2.2 | 2.6 | 3.4 | 2.5 | 1.4 | 1.4 |
| | Catalyst 1B ¹⁷⁾ | — | 3.0 | 3.8 | 2.3 | — | — | — | — | — | — |
| | Catalyst 1C ¹⁸⁾ | 3.0 | 3.0 | 3.0 | 3.0 | 3.0 | 3.0 | 3.0 | 3.0 | 3.0 | 3.0 |
| | Polyisocyanate ¹⁹⁾ | 153 | 164 | 182 | 186 | 185 | 178 | 176 | 181 | 184 | 182 |
| Isocyanate Index | | 110 | 110 | 110 | 110 | 110 | 110 | 110 | 110 | 110 | 110 |
| Foam reactivity | | | | | | | | | | | |
| | Cream time (sec) | 10.3 | 11.6 | 11.3 | 9.0 | 8.2 | 8.0 | 9.8 | 8.1 | 8.6 | 9.1 |
| | Gel time (sec) | 19 | 20 | 20 | 20 | 21 | 20 | 20 | 20 | 20 | 20 |
| | Rise time (sec) | 32 | 38 | 36 | 37 | 36 | 35 | 36 | 37 | 35 | 33 |

| | | | | | | | | | | |
|---|---|---|---|---|---|---|---|---|---|---|
| Foam density (kg/m³) | 31.3 | 33.1 | 30.1 | 31.5 | 30.7 | 30.2 | 30.4 | 30.1 | 30.6 | 30.6 |
| Moldability | X | X | X | X | Δ | Δ | Δ | Δ | Δ | Δ |
| Bond strength (kg/cm²) | 1.0 | 1.1 | 0.8 | 0.7 | 0.6 | 0.6 | 0.6 | 0.7 | 0.6 | 0.5 |

¹⁰⁾ Terephthalic acid type polyester polyol, Terol-1254, OHV = 258 mgKOH/g (manufactured by Oxid)
¹¹⁾ Mannich type polyol DK3810 OHV-314 mgKOH/g (manufactured by Dai-ichi Kogyo Seiyaku Co., Ltd.)
¹²⁾ Silicone type surfactant, L5420 (manufactured by Momentive)
¹³⁾ Trischloropropyl phosphate (manufactured by AkzoNobel, tradename, Fyrol PCF)
¹⁴⁾ Amine carbonates synthesized in Examples and Comparative Examples (1C-1 to 1C-8 in Table 1)
¹⁵⁾ Amount of water added, and in ( ), total amount of water having the amount of water in the amine carbonate added.
¹⁶⁾ N,N,N′-trimethylaminoethylethanolamine (manufactured by TOSOH CORPORATION, tradename: TOYOCAT-RX5)
¹⁷⁾ Mixture of 33% of triethylenediamine and 67% of ethylene glycol (manufactured by TOSOH CORPORATION, tradename: TEDA-L33)
¹⁸⁾ Mixture of 75% of potassium 2-ethylhexanoate and 25% of ethylene glycol
¹⁹⁾ Diphenylmethane diisocyanate, NCO content = 31.0% (manufactured by Nippon Polyurethane Industry Co., Ltd., tradename: MR-200)

Here, measurements of the foam reactivity and the bond strength, evaluation of the foam moldability and measurement of the foam density were carried out as follows.

### Measurement of Foam Reactivity

Cream time: This is a foaming initiation time, and the time when the mixed liquid started foaming was visually measured.

Gel time: This is a resin-forming time, and a slender rod was thrusted into an expanded foam and withdrawn, whereby the time until a cobwebbing phenomenon took place, was measured.

Rise time: The time until the rising of an expanded foam terminated, was visually measured.

### Measurement of Bond Strength

A stainless steel plate (5×5×0.1 cm) with a handle, which was mounted at the bottom surface of a 2 L polyethylene cup, was taken out together with the molded foam after foaming for 10 minutes, and the 90° peel strength was measured by pulling the handle by a pull gauge and taken as the bond strength (kg/cm²) of the foam.

### Moldability of Foam

The appearance and the state of cells of the obtained foam were observed, and the moldability was evaluated as follows.

◯: The surface state of the foam is smooth, and the foam cells are fine.

Δ: Certain irregularities are observed on the surface of the foam, but the foam cells are fine.

×: Irregularities are observed on the surface of the foam, and the foam cells are also large.

### Measurement of Foam Density

A center portion of a foam expanded in a 2 L polyethylene cup was cut into a size of 7 cm×7 cm×15 cm, and the size and weight were accurately measured, whereupon the foam density (kg/m³) was calculated.

As is evident from Examples 3 to 8 in Table 2, in the Preparation Examples for rigid polyurethane foams using the amine carbonates of the present invention, the cream time as the foaming initiation time is fast at a level of about 5 seconds. On the other hand, in Comparative Examples 7 to 9 representing Preparation Examples for rigid polyurethane foams using no amine carbonate, the cream time is slow at a level of about 11 seconds. Further, in Comparative Examples 10 to 14 representing Examples wherein amine carbonates other than those of the present invention were used, the cream time is slow at a level of about 9 seconds, which is slower than in Examples for the amine carbonates of the present invention.

With respect to the foam density, when Examples 4 to 7 are compared with Comparative Examples 7 and 8 and with Comparative Examples 10 to 16 (total amount of water=5 parts by weight), it is evident that in the Examples wherein amine carbonates of the present invention were used, the density can be made lower by from about 6 to 15%.

With respect to the moldability, it is evident from the comparison of Examples 3 to 8 with Comparative Examples 7 to 16 that by the use of amine carbonates of the present invention, the appearance and the state of cells of the molded foam become good.

The bond strength is high at a level of at least 1.0 kg/cm² in each of Examples (Examples 3 to 8) using the amine carbonates of the present invention. On the other hand, in Examples (Comparative Examples 10 to 16) using the amine carbonates of the Comparative Examples, the bond strength is low at a level of from 0.6 to 0.8 kg/cm².

### Preparation Examples 1 to 3

<Preparation of Salt (Amine Carbonate) of Carbon Dioxide with Amine Compound>

Into a 500 ml three-necked flask equipped with a stirrer, 235 g of the amine compound in Preparation Example 1 or 175 g of the amine compound in Preparation Example 2 or 3, as shown in Table 3, and a suitable amount of pure water or a solvent, were charged and adjusted to a liquid temperature of 20° C. with stirring, and then, while adjusting the temperature so that the liquid temperature did not exceed 40° C., carbon dioxide gas was bubbled into the liquid for 3 hours from a liquefied carbon dioxide bottle to prepare an aqueous solution of an amine carbonate (2C-1 or 2C-2) of the present invention or an amine carbonate (2C-3) of Comparative Example. The heat generation by the reaction of the amine compound with carbon dioxide was terminated in about 1 hour. From the obtained amine carbonate aqueous solution, 200 g was sampled and used for the following analyses and evaluation as a foaming agent for urethane.

The concentrations of components [Composition (wt %)] of the amine carbonate aqueous solution are also shown in Table 3. In Table 3, amine compound 2A and amine compound 2B correspond to the amine compound (I) of the present invention.

Further, the amine carbonate (2C-1) used in Example 10 given hereinafter was obtained in a necessary amount of 1,100 g by repeating the preparation of Preparation Example 1 three times.

TABLE 3

| | | Preparation Examples | | |
|---|---|---|---|---|
| | | 1 | 2 | 3 |
| Composition (%) | Amine compound 2A¹⁾ | 60.6 | — | — |
| | Amine compound 2B²⁾ | — | 47.3 | — |
| | Amine compound 2C³⁾ | — | — | 42.3 |
| | Carbon dioxide | 9.5 | 5.4 | 15.4 |
| | Water | 29.9 | 47.3 | 42.3 |
| | Solvent⁴⁾ | — | — | — |

| | | | |
|---|---|---|---|
| Amine carbonate | 2C-1 | 2C-2 | 2C-3 |

¹⁾Polyoxyalkylenediamine (manufactured by Huntsman, tradename: Jeffamine D230)
²⁾Polyoxyalkylenediamine (manufactured by Huntsman, tradename: Jeffamine D400)
³⁾N-methylethanolamine (reagent)
⁴⁾Ethylene glycol (reagent)

Here, the concentration of carbon dioxide component was obtained by subjecting each amine carbonate aqueous solution to a titration analysis by a sodium methoxide solution (0.1N methanol solution). Further, the concentrations of the amine compound, water and the solvent were obtained by calculation from the charged amounts.

### Examples 9 to 17 and Comparative Examples 17 to 25

### <Production of Rigid Polyurethane Foam>

Polyol 2A, polyol 2B, a foam stabilizer, a flame retardant, catalyst 2A to catalyst 2H, water and an amine carbonate aqueous solution (2C-1 to 2C-3), were mixed in a ratio shown in Table 4 to obtain a premix liquid. 65 g of this premix liquid was taken into a 300 ml polyethylene cup, and the temperature was adjusted to 5° C. To this 300 ml polyethylene cup, a polyisocyanate in Table 4 having the temperature adjusted to 5° C. in a separate container was quickly added in such an amount that the isocyanate index became 110. After stirring at 6,000 rpm for 3 seconds by a high speed stirring machine, this mixture was quickly transferred to a 2L polyethylene cup provided having the temperature adjusted to from 22 to 25° C. and subjected to foam molding. At that time, in the 2L polyethylene cup, the foam reactivity was measured. Further, the moldability, the foam density and the foam odor of the obtained rigid polyurethane foam were evaluated. These results are shown in Table 4.

TABLE 4

| | | Examples | | | | | | | | |
|---|---|---|---|---|---|---|---|---|---|---|
| | | 9 | 10 | 11 | 12 | 13 | 14 | 15 | 16 | 17 |
| Foaming | Polyol 2A ¹⁾ | 50 | 50 | 50 | 50 | 50 | 50 | 50 | 50 | 50 |
| formulation | Polyol 2B ²⁾ | 50 | 50 | 50 | 50 | 50 | 50 | 50 | 50 | 50 |
| (parts by | Foam stabilizer ³⁾ | 1.8 | 1.8 | 1.8 | 1.8 | 1.8 | 1.8 | 1.8 | 1.8 | 1.8 |
| weight) | Foam stabilizer ⁴⁾ | 0.3 | 0.3 | 0.3 | 0.3 | 0.3 | 0.3 | 0.3 | 0.3 | 0.3 |
| | Flame retardant ⁵⁾ | 20 | 20 | 20 | 20 | 20 | 20 | 20 | 20 | 20 |
| | Amine compound ⁶⁾ | — | — | — | — | — | — | — | — | — |
| | Amine carbonate | 2C-1 | 2C-1 | 2C-1 | 2C-2 | 2C-1 | 2C-1 | 2C-1 | 2C-1 | 2C-1 |
| | (added amount) ⁷⁾ | 9.5 | 9.5 | 9.5 | 9.5 | 9.5 | 9.5 | 9.5 | 9.5 | 9.5 |
| | Added amount of water | 1.7 | 1.7 | 1.7 | 0.00 | 1.7 | 1.7 | 1.7 | 1.7 | 1.7 |
| | (total amount of water) ⁸⁾ | (4.5) | (4.5) | (4.5) | (4.5) | (4.5) | (4.5) | (4.5) | (4.5) | (4.5) |
| | Viscosity-reducing | 5 | 5 | 5 | 5 | 5 | 5 | 5 | 5 | 5 |
| | agent ⁹⁾ | | | | | | | | | |
| | Catalyst 2A ¹⁰⁾ | 4.0 | 6.0 | 8.0 | 4.0 | 4.0 | 4.0 | 4.0 | 4.0 | 6.0 |
| | Catalyst 2B ¹¹⁾ | — | — | — | — | 1.4 | | — | — | — |
| | Catalyst 2C ¹²⁾ | — | — | — | — | — | 1.5 | — | — | — |
| | Catalyst 2D ¹³⁾ | — | — | — | — | — | — | 3.0 | — | — |
| | Catalyst 2E ¹⁴⁾ | — | — | — | — | — | — | — | — | — |
| | Catalyst 2F ¹⁵⁾ | — | — | — | — | — | — | — | — | — |
| | Catalyst 2G ¹⁶⁾ | — | — | — | — | — | — | — | — | — |
| | Catalyst 2H ¹⁷⁾ | 3.0 | 3.0 | 3.0 | 3.0 | — | — | — | — | — |
| | Polyisocyanate ¹⁸⁾ | 164 | 166 | 168 | 160 | 164 | 164 | 164 | 162 | 164 |

| | | | | | | | | | |
|---|---|---|---|---|---|---|---|---|---|
| Isocyanate Index | 110 | 110 | 110 | 110 | 110 | 110 | 110 | 110 | 110 |
| Foam reactivity | | | | | | | | | |
| Cream time (sec) | 4.5 | 4.4 | 4.0 | 5.7 | 4.3 | 4.4 | 4.4 | 4.4 | 4.3 |
| Gel time (sec) | 18 | 14 | 11 | 19 | 16 | 16 | 18 | 22 | 18 |
| Rise time (sec) | 30 | 27 | 26 | 30 | 27 | 28 | 27 | 30 | 28 |
| Foam density (kg/m³) | 23.0 | 22.8 | 21.6 | 24.3 | 23.3 | 22.8 | 28.4 | 29.5 | 26.0 |
| Moldability | ◯ | ◯ | ◯ | ◯ | ◯ | ◯ | Δ | Δ | ◯ |
| Foam odor | ◯ | ◯ | ◯ | ◯ | ◯ | ◯ | Δ | ◯ | ◯ |

| | | Comparative Examples | | | | | | | | |
|---|---|---|---|---|---|---|---|---|---|---|
| | | 17 | 18 | 19 | 20 | 21 | 22 | 23 | 24 | 25 |
| Foaming | Polyol 2A ¹⁾ | 50 | 50 | 50 | 50 | 50 | 50 | 50 | 50 | 50 |
| formulation | Polyol 2B ²⁾ | 50 | 50 | 50 | 50 | 50 | 50 | 50 | 50 | 50 |
| (parts by | Foam stabilizer ³⁾ | 1.8 | 1.8 | 1.8 | 1.8 | 1.8 | 1.8 | 1.8 | 1.8 | 1.8 |
| weight) | Foam stabilizer ⁴⁾ | 0.3 | 0.3 | 0.3 | 0.3 | 0.3 | 0.3 | 0.3 | 0.3 | 0.3 |
| | Flame retardant ⁵⁾ | 20 | 20 | 20 | 20 | 20 | 20 | 20 | 20 | 20 |
| | Amine compound ⁶⁾ | — | — | — | — | — | — | 5.8 | — | — |
| | Amine carbonate | — | — | — | — | — | — | — | — | 2C-3 |
| | (added amount) ⁷⁾ | | | | | | | | | 5.8 |
| | Added amount of water | 4.5 | 4.5 | 4.5 | 4.5 | 4.5 | 4.5 | 4.5 | 4.5 | 2.03 |
| | (total amount of water) ⁸⁾ | | | | | | | | | (4.5) |
| | Viscosity-reducing | 5 | 5 | 5 | 5 | 5 | 5 | 5 | 5 | 5 |
| | agent ⁹⁾ | | | | | | | | | |
| | Catalyst 2A ¹⁰⁾ | 4.0 | 6.0 | 8.0 | 4.0 | 10.0 | 14.0 | 4.0 | — | — |
| | Catalyst 2B ¹¹⁾ | — | — | — | — | — | — | — | — | — |
| | Catalyst 2C ¹²⁾ | — | — | — | — | — | — | — | — | — |
| | Catalyst 2D ¹³⁾ | — | — | — | — | — | — | — | — | — |
| | Catalyst 2E ¹⁴⁾ | 0.3 | 0.3 | 0.3 | — | — | — | — | — | — |
| | Catalyst 2F ¹⁵⁾ | — | — | — | — | — | — | — | 4.0 | — |
| | Catalyst 2G ¹⁶⁾ | — | — | — | — | — | — | — | — | 4.0 |
| | Catalyst 2H ¹⁷⁾ | — | — | — | 3.0 | 3.0 | 3.0 | 3.0 | 3.0 | 3.0 |
| | Polyisocyanate ¹⁸⁾ | 154 | 156 | 158 | 156 | 162 | 167 | 164 | 152 | 164 |

| | | | | | | | | | |
|---|---|---|---|---|---|---|---|---|---|
| Isocyanate Index | 110 | 110 | 110 | 110 | 110 | 110 | 110 | 110 | 110 |
| Foam reactivity | | | | | | | | | |
| Cream time (sec) | 6.8 | 5.1 | 4.4 | 10.4 | 5.4 | 4.2 | 7.6 | 6.0 | 7.5 |
| Gel time (sec) | 16 | 12 | 10 | 20 | 10 | 8 | 16 | 12 | 18 |
| Rise time (sec) | 36 | 28 | 24 | 30 | 17 | 16 | 25 | 20 | 27 |
| Foam density (kg/m³) | 24.7 | 24.2 | 23.5 | 23.1 | 22.3 | 20.4 | 26.6 | 26.6 | 29.1 |
| Moldability | Δ | ◯ | ◯ | X | ◯ | ◯ | Δ | Δ | X |
| Foam odor | ◯ | ◯ | ◯ | ◯ | Δ | X | ◯ | X | Δ |

¹⁾ Terephthalic acid type polyester polyol, Terol-1254, OHV = 258 mgKOH/g (manufactured by Oxid)
²⁾ Mannich type polyol DK3810 OHV-314 mgKOH/g (manufactured by Dai-ichi Kogyo Seiyaku Co., Ltd.)
³⁾ Silicone type surfactant, L6188 (manufactured by Momentive)
⁴⁾ Silicone type surfactant, L6900 (manufactured by Momentive)
⁵⁾ Tris(chloropropyl) phosphate (manufactured by Daihachi Chemical Industry Co., Ltd., tradename: TMCPP)
⁶⁾ Polyoxyalkylenediamine (manufactured by Huntsman, tradename: Jeffamine D230)
⁷⁾ Polyoxyalkylenediamine carbonate shown in Table 3
⁸⁾ Amount of water added, and in ( ), total amount of water having the amount of water in the amine carbonate added.
⁹⁾ Propylene carbonate (reagent)
¹⁰⁾ N,N,N′-trimethylaminoethylethanolamine (manufactured by TOSOH CORPORATION, tradename: TOYOCAT-RX5)
¹¹⁾ Bismuth neodecanoate (manufactured by Shepherd Chemical, tradename: BICAT-H)
¹²⁾ Zinc neodecanoate (manufactured by Shepherd Chemical, tradename: BICAT-Z)
¹³⁾ Quaternary ammonium catalyst (manufactured by TOSOH CORPORATION, TOYOCAT-TRX)
¹⁴⁾ Lead 2-ethylhexanoate, lead concentration: 20% (manufactured by Nihon Kagaku Sangyo Co., Ltd., tradename: NIKKA OCTHIX)
¹⁵⁾ N,N,N′,N″,N″-pentamethyldiethylenetriamine (manufactured by TOSOH CORPORATION, tradename: TOYOCAT-DT)
¹⁶⁾ Mixture of 33% of triethylenediamine and 67% of ethylene glycol (manufactured by TOSOH CORPORATION, tradename: TEDA-L33)
¹⁷⁾ Mixture of 75% of potassium 2-ethylhexanoate and 25% of ethylene glycol
¹⁸⁾ Diphenylmethane diisocyanate, NCO content = 31.2% (manufactured by Nippon Polyurethane Industry Co., Ltd., tradename: CORONATE 1130)

Here, measurement of the foam reactivity, evaluation of the foam moldability, measurement of the foam density and judgment of the foam odor were carried out as follows.

### Measurement of Foam Reactivity

Cream time: This is a foaming initiation time, and the time when the mixed liquid started foaming was visually measured.

Gel time: This is a resin-forming time, and a slender rod was thrusted into an expanded foam and withdrawn, whereby the time until a cobwebbing phenomenon took place, was measured.

Rise time: The time until the rising of an expanded foam terminated, was visually measured.

### Moldability of Foam

The appearance and the state of cells of the obtained foam were observed, whereby the moldability was evaluated as follows.

◯: The surface state of the foam is smooth, and the foam cells are fine.

Δ: Certain irregularities are observed on the surface of the foam, but the foam cells are fine.

×: Irregularities are observed on the surface of the foam, and the foam cells are also large.

### Measurement of the Foam Density

A center portion of the foam expanded in a 2L polyethylene cup was cut into a size of 6 cm×6 cm×10 cm, and the size and weight were accurately measured, whereupon the foam density (kg/m³) was calculated.

### Judgment of Foam Odor

The foam cut for the measurement of the foam density was put and sealed in a polyethylene bag, and the odor in the polyethylene bag was smelled by three monitors, and the odor intensity was evaluated as divided into three grades.

◯: No substantial odor from the foam is smelled.

Δ: An odor from the foam is smelled.

×: An odor from the foam is strong.

As is evident from Table 4, in Examples (Examples 9 to 11) for forming rigid polyurethane foams using the amine carbonate obtained in Preparation Example 1, the cream time as the foaming initiation time was fast, and the initial foaming property was excellent as compared with Comparative Examples wherein the amount of N,N,N′-trimethylaminoethylethanolamine (manufactured by TOSOH CORPRATION, tradename: TOYOCAT-RX5) as the amine catalyst was the same, in spite of the fact that the liquid temperatures of the premix liquid and the polyisocyanate were as low as 5° C. That is, Comparative Examples 17 to 19 represent examples wherein lead 2-ethylhexanoate was added without using the amine carbonate obtained in Preparation Example 1, wherein the cream time was slow as compared with Examples of the present invention wherein the amount of N,N,N′-trimethylaminoethylethanolamine as the amine catalyst added was the same, and in order to obtain the same reactivity, a larger amount of the amine catalyst would be required.

Further, Example 12 is an example wherein the amine carbonate obtained in Preparation Example 2 was used, the cream time was fast, and the initial foaming property was excellent.

Further, Examples 13 to 15 are examples wherein bismuth neodecanoate, zinc neodecanoate, or a quaternary ammonium salt catalyst was used instead of a potassium 2-ethylhexanoate catalyst, wherein the cream time was fast in the same manner as in Examples 9 to 11 wherein a potassium 2-ethylhexanoate catalyst was used.

Further, Examples 16 and 17 are examples wherein only N,N,N′-trimethylaminoethylethanolamine being an amine catalyst was used as the catalyst, wherein the cream time as the foaming initiation time was fast, and the initial foaming property was excellent.

Whereas, Comparative Examples 20 to 22 are examples wherein N,N,N′-trimethylaminoethylethanolamine was increased to facilitate the cream time, but it is required to add a large amount of the amine catalyst in order to obtain the cream time equal to the one obtained in Examples wherein the amine carbonate was used.

Further, Comparative Example 23 is an example wherein only the amine compound was added instead of the amine carbonate, wherein the cream time was slow as compared with a case where the amine carbonate was used.

Further, Comparative Example 24 is an example wherein N,N,N′,N″,N″-pentamethyldiethylenetriamine (manufactured by TOSOH CORPORATION, tradename: TOYOCAT-DT) was used instead of N,N,N′-trimethylaminoethylethanolamine, wherein improvement of the cream time was inadequate, and the odor of the foam was strong.

Further, Comparative Example 25 is an example wherein the N-methylethanolamine carbonate obtained in Preparation Example 3 was used, wherein improvement of the cream time was inadequate as compared with Examples of the present invention.

From these results, it is evident that in the method for producing a spray type rigid polyurethane foam of the present invention, it is possible to produce a rigid polyurethane foam having a fast foaming initiation time without polluting the environment.

### Example 18 and Comparative Examples 26 and 27

### <Production of Spray Type Rigid Polyurethane Foam>

Example 18 represents an example wherein a spray type rigid polyurethane foam was produced by using the amine carbonate obtained in Preparation Example 1. In the raw material blend ratio shown in Table 5, about 15 kg of each of premixes in Example 18 and Comparative Examples 26 and 27, was formulated, thoroughly mixed and set in a spray machine. Likewise, the polyisocyanate shown in Table 5 was set in a spray machine, and then, the spray machine foaming was carried out under the following foaming conditions. The reactivity during the foaming was measured with respect to the mixed liquid ejected for about 0.5 second from the spray gun to a slate (30×30 cm) adjusted to a surface temperature of 0° C. With respect to the comparison of the core density of the foam and the moldability of the foam, a foam layer having a thickness of about 50 mm was formed on a slate (30×30 cm), measured and compared. The results are shown in Table 5.

TABLE 5

| | | | Comparative | |
|---|---|---|---|---|
| | | Examples | Examples | |
| | | 18 | 26 | 27 |
| Foaming | Polyol 2A¹⁾ | 50 | 50 | 50 |
| formulation | Polyol 2B²⁾ | 50 | 50 | 50 |
| (parts by weight) | Foam stabilizer³⁾ | 1.8 | 1.8 | 1.8 |
| | Foam stabilizer⁴⁾ | 0.3 | 0.3 | 0.3 |
| | Flame retardant⁵⁾ | 20 | 20 | 20 |
| | Amine carbonate⁶⁾ | 2C-1 | — | — |
| | (added amount) | 9.5 | | |
| | Added amount of⁷⁾ | 1.7 | 4.5 | 4.5 |
| | water | (4.5) | | |
| | (total amount of | | | |
| | water) | | | |
| | Viscosity-reducing⁸⁾ | 5 | 5 | 5 |
| | agent | | | |
| | Catalyst 2A⁹⁾ | 4.5 | 5.0 | 4.5 |
| | Catalyst 2B¹⁰⁾ | — | — | 0.3 |
| | Catalyst 2C¹¹⁾ | 3.0 | 3.0 | — |
| | Polyisocyanate¹²⁾ | Premix/Polyisocyanate = | | |
| | | 1/1 (volume ratio) | | |
| Foam reactivity | Cream time (sec) | 1.2 | 5.1 | 1.5 |
| | Rise time (sec) | 6 | 15 | 5 |

| | | | |
|---|---|---|---|
| Foam density (kg/m³) | 28.1 | 28.5 | 29.4 |
| Moldability | ◯ | Δ | ◯ |

¹⁾Terephthalic acid type polyester polyol, Terol-1254, OHV = 258 mgKOH/g (manufactured by Oxid)
²⁾Mannich type polyol DK3810 OHV-314 mgKOH/g (manufactured by Dai-ichi Kogyo Seiyaku Co., Ltd.)
³⁾Silicone type surfactant, L6188 (manufactured by Momentive)
⁴⁾Silicone type surfactant, L6900 (manufactured by Momentive)
⁵⁾Tris(chloropropyl) phosphate (manufactured by Daihachi Chemical Industry Co., Ltd., tradename: TMCPP)
⁶⁾Polyoxyalkylenediamine carbonate shown in Table 3
⁷⁾Amount of water added, and in ( ), total amount of water having the amount of water in the amine carbonate added.
⁸⁾Propylene carbonate (reagent)
⁹⁾N,N,N′-trimethylaminoethylethanolamine (manufactured by TOSOH CORPORATION, tradename: TOYOCAT-RX5)
¹⁰⁾Lead 2-ethylhexanoate, lead concentration: 20% (manufactured by Nihon Kagaku Sangyo Co., Ltd., tradename: NIKKA OCTHIX)
¹¹⁾Mixture of 75% of potassium 2-ethylhexanoate and 25% of ethylene glycol
¹²⁾Diphenylmethane diisocyanate, NCO content = 31.2% (manufactured by Nippon Polyurethane Industry Co., Ltd., tradename: CORONATE 1130)

Here, the foaming conditions, measurement of the reactivity and evaluation of the moldability of the foam were as follows.

### Foaming Conditions

Spray machine: Manufactured by GUSMER, tradename: H-2000

Mixing ratio: Prembdisocyanate=1/1 (volume ratio)

Raw material liquid temperature: 40±1° C.

Spray substrate: Slate (30×30 cm)

Surface temperature of substrate: 0° C.

### Measurement of Reactivity

Cream time: The time when rising of a foam started was measured by means of a stopwatch.

Rise time: The time when rising of the foam terminated, was measured by means of a stopwatch.

### Moldability of Foam

The appearance of a foam molded on the slate was visually observed, and the moldability was evaluated as follows.

◯: The surface of the foam is flat.

Δ: Slight irregularities are observed on the surface of the foam.

×: Many irregularities are observed on the surface of the foam.

### Core Density of Foam

A center portion of the foam molded on the slate was cut into a size of 200×200×30 mm, and the size and weight were accurately measured, whereupon the core density was calculated.

Example 18 is an example for producing a spray type rigid polyurethane foam by using the amine carbonate obtained in Preparation Example 1. It is evident that also in the foaming by means of a spray machine, the cream time as the foaming initiation time is fast and the initial foaming property is excellent. Comparative Example 26 is an example wherein a potassium 2-ethylhexanoate and N,N,N′-trimethylaminoethylethanolamine were used as the catalyst, wherein the cream time was slow. Comparative Example 27 is a conventional example wherein lead 2-ethylhexanoate was used.

### <Production of Amine Compound>

Amine compounds (3A and 3B) used in Preparation Examples 4 and 5 given hereinafter, were produced by the methods shown in the following Production Examples 1 and 2.

### Production Example 1

Into a 1,000 ml autoclave equipped with a stirrer, 150 g (1.45 mol) of diethylenetriamine (manufactured by TOSOH CORPORATION, tradename: DETA), 150 g of water and 0.5 g of catalyst Pd—C (5% supported) were charged. The autoclave was closed, and after replacement with hydrogen, the temperature was raised to 120° C. with stirring. While continuously introducing hydrogen under a pressure of 3 MPa into the autoclave, 236 g (2.90 mol) of a 37% formalin aqueous solution was supplied by a pump over a period of 4 hours. After carrying out an aging reaction for 1 hour, the reaction liquid was cooled and taken out.

Water was distilled off from the reaction liquid by means of a distillation apparatus, and under reduced pressure, an N-methylated diethylenetriamine as the product was distilled and 141 g thereof was obtained. This product was analyzed by gas chromatograph and ¹H-NMR analysis, whereby it was found that 41% of active hydrogen atoms bonded to nitrogen atoms were converted to methyl groups. Further, this reaction product was analyzed by gas chromatography, whereby it was found from the measurement chart that this product had a composition comprising 25% of a monomethyl derivative, 52% of a dimethyl derivative, 18% of a trimethyl derivative and 5% of a tetramethyl derivative.

### Production Example 2

The reaction and distillation were carried out under the same conditions as in Production Example 1 except that the 37% formalin aqueous solution was changed to 353 g (4.35 mol), to obtain 162 g of an N-methylated diethylenetriamine. As a result of the analyses in the same manner as in Production Example 1, it was found that 60% of active hydrogen atoms bonded to nitrogen atoms in the diethyenetriamine were converted to methyl groups, and this product had a composition comprising 6% of a monomethyl derivative, 22% of a dimethyl derivative, 44% of a trimethyl derivative, 23% of a tetramethyl derivative and 5% of a pentamethyl derivative.

<Production of Salt (Amine Carbonate) of Carbon Dioxide with an Amine Compound>

### Preparation Examples 4 to 9

Into a 500 ml three-necked flask equipped with a stirrer, the amine compound shown in Table 6 and a suitable amount of pure water or a solvent were charged, and with stirring, the liquid temperature was adjusted to 20° C. Then, while carrying out the temperature adjustment so that the liquid temperature did not exceed 40° C., carbon dioxide gas was bubbled for 3 hours into the liquid from a liquefied carbon dioxide bobble to prepare an aqueous solution of the amine carbonate (3C-1 to 3C-5) of the present invention or the amine carbonate (3C-6) of Comparative Example. Here, in Preparation Examples 4 to 7 and 9, 175 g of the amine compound was used, and in Preparation Example 8, 88 g of the amine compound was used. The heat generation by the reaction of the amine compound with carbon dioxide was terminated in 1 hour. 200 g was sampled from the obtained aqueous solution of the amine carbonate and used for the following analyses and evaluation as a foaming agent for urethane.

Concentrations of components in the aqueous solution of the amine carbonate [Composition (wt %)] are also shown in Table 6. In Table 6, amine compounds 3A and 3B correspond to the amine compound (II) of the present invention, amine compound 3C corresponds to the amine compound (V) of the present invention, amine compound 3D corresponds to the amine compound (IV) of the present invention, and amine compound 3E corresponds to the amine compound (III) of the present invention.

TABLE 6

| | | Preparation Example | | | | | |
|---|---|---|---|---|---|---|---|
| | | 4 | 5 | 6 | 7 | 8 | 9 |
| Compo- | Amine compound | 41.1 | | — | — | — | — |
| sition | 3A ¹⁾ | | | | | | |
| (%) | Amine compound | — | 44.3 | — | — | — | — |
| | 3B ²⁾ | | | | | | |
| | Amine compound | — | — | 44.0 | — | — | — |
| | 3C ³⁾ | | | | | | |
| | Amine compound | — | — | — | 43.0 | — | — |
| | 3D ⁴⁾ | | | | | | |
| | Amine compound | — | — | — | — | 22.9 | — |
| | 3E ⁵⁾ | | | | | | |
| | Amine compound | — | — | — | — | — | 42.3 |
| | 3F ⁶⁾ | | | | | | |
| | Carbon dioxide | 17.8 | 11.4 | 12.0 | 14.0 | 8.3 | 15.4 |
| | water | 41.1 | 44.3 | 44.0 | 43.0 | 22.9 | 42.3 |
| | Solvent ⁷⁾ | — | — | — | — | 45.9 | — |

| | | | | | | |
|---|---|---|---|---|---|---|
| Amine carbonate | 3C-1 | 3C-2 | 3C-3 | 3C-4 | 3C-5 | 3C-6 |

¹⁾ Dimethylated diethylenetriamine obtained in Production Example 1
²⁾ Trimethylated diethylenetriamine obtained in Production Example 2
³⁾ Morpholine (reagent)
⁴⁾ Piperidine (reagent)
⁵⁾ N-methylpiperazine (reagent)
⁶⁾ N-methylethanolamine (reagent)
⁷⁾ Ethylene glycol (reagent)

Here, the concentration of the carbon dioxide component was obtained by subjecting each amine carbonate aqueous solution to a titration analysis with sodium methoxide solution (0.1N methanol solution). Further, the concentrations of the amine compound, water and the solvent were obtained from the charged amounts by calculation.

Further, amine carbonates (3C-1 and 3C-3) of the present invention used in Examples 29 and 30 given hereinafter, were obtained in necessary amounts based on Preparation Examples 4 and 6, respectively.

### <Production of Rigid Polyurethane Foam>

### Examples 19 to 28 and Comparative Examples 28 to 35

Polyol 3A, polyol 3B, a foam stabilizer, a flame retardant, catalyst 3A to catalyst 3H, water and an amine carbonate aqueous solution (3C-1 to 3C-6), were mixed in a ratio shown in Table 7 to obtain a premix liquid. 65 g of this premix liquid was taken into a 300 ml polyethylene cup, and the temperature was adjusted to 5° C. To this 300 ml polyethylene cup, a polyisocyanate in Table 7 having the temperature adjusted to 5° C. in a separate container was quickly added in such an amount that the isocyanate index became 110. After stirring at 6,000 rpm for 3 seconds by a high speed stirring machine, this mixture was quickly transferred to a 2 L polyethylene cup having the temperature adjusted to from 22 to 25° C. and subjected to foam molding. At that time, in the 2 L polyethylene cup, the foam reactivity was measured. Further, the moldability, the foam density and the foam odor of the obtained rigid polyurethane foam were evaluated. These results are shown in Table 7.

TABLE 7

| | | Examples | | | | | | | | | |
|---|---|---|---|---|---|---|---|---|---|---|---|
| | | 19 | 20 | 21 | 22 | 23 | 24 | 25 | 26 | 27 | 28 |
| Foaming | Polyol 3A ¹⁾ | 50 | 50 | 50 | 50 | 50 | 50 | 50 | 50 | 50 | 50 |
| formulation | Polyol 3B ²⁾ | 50 | 50 | 50 | 50 | 50 | 50 | 50 | 50 | 50 | 50 |
| (parts by | Foam stabilizer ³⁾ | 1.8 | 1.8 | 1.8 | 1.8 | 1.8 | 1.8 | 1.8 | 1.8 | 1.8 | 1.8 |
| weight) | Foam stabilizer ⁴⁾ | 0.3 | 0.3 | 0.3 | 0.3 | 0.3 | 0.3 | 0.3 | 0.3 | 0.3 | 0.3 |
| | Flame retardant ⁵⁾ | 20 | 20 | 20 | 20 | 20 | 20 | 20 | 20 | 20 | 20 |
| | Amine carbonate | 3C-1 | 3C-2 | 3C-3 | 3C-3 | 3C-3 | 3C-4 | 3C-5 | 3C-1 | 3C-1 | 3C-1 |
| | (added amount) ⁶⁾ | 5.1 | 7.9 | 7.5 | 7.5 | 7.5 | 6.4 | 10.8 | 5.1 | 5.1 | 5.1 |
| | Added amount of water | 2.4 | 1.0 | 1.2 | 1.2 | 1.2 | 1.7 | 2.0 | 2.4 | 2.4 | 2.4 |
| | (total amount of water) ⁷⁾ | (4.5) | (4.5) | (4.5) | (4.5) | (4.5) | (4.5) | (4.5) | (4.5) | (4.5) | (4.5) |
| | Viscosity-reducing | 5 | 5 | 5 | 5 | 5 | 5 | 5 | 5 | 5 | 5 |
| | agent ⁸⁾ | | | | | | | | | | |
| | Catalyst 3A ⁹⁾ | 4.0 | 4.0 | 4.0 | 6.0 | 8.0 | 4.0 | 4.0 | 4.0 | 4.0 | 4.0 |
| | Catalyst 3B ¹⁰⁾ | — | — | — | — | — | — | — | 1.4 | — | — |
| | Catalyst 3C ¹¹⁾ | — | — | — | — | — | — | — | — | 1.5 | — |
| | Catalyst 3D ¹²⁾ | — | — | — | — | — | — | — | — | — | 3.0 |
| | Catalyst 3E ¹³⁾ | — | — | — | — | — | — | — | — | — | — |
| | Catalyst 3F ¹⁴⁾ | — | — | — | — | — | — | — | — | — | — |
| | Catalyst 3G ¹⁵⁾ | — | — | — | — | — | — | — | — | — | — |
| | Catalyst 3H ¹⁶⁾ | 3.0 | 3.0 | 3.0 | 3.0 | 3.0 | 3.0 | 3.0 | — | — | — |
| | Polyisocyanate ¹⁷⁾ | 164 | 169 | 162 | 164 | 166 | 162 | 173 | 164 | 164 | 164 |
| Isocyanate Index | | 110 | 110 | 110 | 110 | 110 | 110 | 110 | 110 | 110 | 110 |
| Foam reactivity | | | | | | | | | | | |
| | Cream time (sec) | 5.7 | 5.6 | 5.5 | 4.9 | 3.9 | 5.6 | 5.6 | 5.5 | 5.6 | 5.5 |
| | Gel time (Sec) | 15 | 15 | 17 | 14 | 11 | 16 | 16 | 16 | 15 | 17 |
| | Rise time (sec) | 28 | 29 | 29 | 23 | 21 | 30 | 30 | 29 | 30 | 31 |

| | | | | | | | | | | |
|---|---|---|---|---|---|---|---|---|---|---|
| Foam density (kg/m³) | 23.4 | 23.6 | 23.8 | 23.2 | 22.8 | 23.9 | 23.8 | 23.3 | 23.0 | 28.4 |
| Moldability | ◯ | ◯ | ◯ | ◯ | ◯ | ◯ | ◯ | ◯ | ◯ | Δ |
| Foam odor | ◯ | ◯ | ◯ | ◯ | ◯ | ◯ | ◯ | ◯ | ◯ | Δ |

| | | Comparative Examples | | | | | | | |
|---|---|---|---|---|---|---|---|---|---|
| | | 28 | 29 | 30 | 31 | 32 | 33 | 34 | 35 |
| Foaming | Polyol 3A ¹⁾ | 50 | 50 | 50 | 50 | 50 | 50 | 50 | 50 |
| formulation | Polyol 3B ²⁾ | 50 | 50 | 50 | 50 | 50 | 50 | 50 | 50 |
| (parts by | Foam stabilizer ³⁾ | 1.8 | 1.8 | 1.8 | 1.8 | 1.8 | 1.8 | 1.8 | 1.8 |
| weight) | Foam stabilizer ⁴⁾ | 0.3 | 0.3 | 0.3 | 0.3 | 0.3 | 0.3 | 0.3 | 0.3 |
| | Flame retardant ⁵⁾ | 20 | 20 | 20 | 20 | 20 | 20 | 20 | 20 |
| | Amine carbonate | — | — | — | — | — | — | — | 3C-6 |
| | (added amount) ⁶⁾ | | | | | | | | 5.8 |
| | Added amount of water | 4.5 | 4.5 | 4.5 | 4.5 | 4.5 | 4.5 | 4.5 | 2.0 |
| | (total amount of water) ⁷⁾ | | | | | | | | (4.5) |
| | Viscosity-reducing | 5 | 5 | 5 | 5 | 5 | 5 | 5 | 5 |
| | agent ⁸⁾ | | | | | | | | |
| | Catalyst 3A ⁹⁾ | 4.0 | 6.0 | 8.0 | 4.0 | 6.0 | 8.0 | — | — |
| | Catalyst 3B ¹⁰⁾ | — | — | — | — | — | — | — | — |
| | Catalyst 3C ¹¹⁾ | — | — | — | — | — | — | — | — |
| | Catalyst 3D ¹²⁾ | — | — | — | — | — | — | — | — |
| | Catalyst 3E ¹³⁾ | 0.3 | 0.3 | 0.3 | — | — | — | — | — |
| | Catalyst 3F ¹⁴⁾ | — | — | — | — | — | — | 4.0 | — |
| | Catalyst 3G ¹⁵⁾ | — | — | — | — | — | — | — | 4.0 |
| | Catalyst 3H ¹⁶⁾ | — | — | — | 3.0 | 3.0 | 3.0 | 3.0 | 3.0 |
| | Polyisocyanate ¹⁷⁾ | 154 | 156 | 158 | 156 | 158 | 160 | 152 | 164 |
| Isocyanate Index | | 110 | 110 | 110 | 110 | 110 | 110 | 110 | 110 |
| Foam reactivity | | | | | | | | | |
| | Cream time (sec) | 6.8 | 5.1 | 4.4 | 10.4 | 8.0 | 6.5 | 6.0 | 7.5 |
| | Gel time (Sec) | 16 | 12 | 10 | 20 | 15 | 12 | 12 | 18 |
| | Rise time (sec) | 36 | 28 | 24 | 30 | 23 | 21 | 20 | 27 |

| | | | | | | | | |
|---|---|---|---|---|---|---|---|---|
| Foam density (kg/m³) | 24.7 | 24.2 | 23.5 | 23.1 | 22.8 | 22.0 | 26.6 | 29.1 |
| Moldability | Δ | ◯ | ◯ | X | X | Δ | Δ | X |
| Foam odor | ◯ | ◯ | ◯ | ◯ | ◯ | Δ | X | Δ |

¹⁾ Terephthalic acid type polyester polyol, Terol-1254, OHV = 258 mgKOH/g (manufactured by Oxid)
²⁾ Mannich type polyol DK3810 OHV-314 mgKOH/g (manufactured by Dai-ichi Kogyo Seiyaku Co., Ltd.)
³⁾ Silicone type surfactant, L6188 (manufactured by Momentive)
⁴⁾ Silicone type surfactant, L6900 (manufactured by Momentive)
⁵⁾ Tris(chloropropyl) phosphate (manufactured by Daihachi Chemical Industry Co., Ltd., tradename: TMCPP)
⁶⁾ Polyoxyalkylenediamine (manufactured by Huntsman, tradename: Jeffamine D230)
⁷⁾ Polyoxyalkylenediamine carbonate shown in Table 3
⁸⁾ Amount of water added, and in ( ), total amount of water having the amount of water in the amine carbonate added.
⁹⁾ Propylene carbonate (reagent)
¹⁰⁾ N,N,N′-trimethylaminoethylethanolamine (manufactured by TOSOH CORPORATION, tradename: TOYOCAT-RX5)
¹¹⁾ Bismuth neodecanoate (manufactured by Shepherd Chemical, tradename: BICAT-H)
¹²⁾ Zinc neodecanoate (manufactured by Shepherd Chemical, tradename: BICAT-Z)
¹³⁾ Quaternary ammonium catalyst (manufactured by TOSOH CORPORATION, TOYOCAT-TRX)
¹⁴⁾ Lead 2-ethylhexanoate, lead concentration: 20% (manufactured by Nihon Kagaku Sangyo Co., Ltd., tradename: NIKKA OCTHIX)
¹⁵⁾ N,N,N′,N″,N″-pentamethyldiethylenetriamine (manufactured by TOSOH CORPORATION, tradename: TOYOCAT-DT)
¹⁶⁾ Mixture of 33% of triethylenediamine and 67% of ethyiene glycol (manufactured by TOSOH CORPORATION, tradename: TEDA-L33)
¹⁷⁾ Mixture of 75% of potassium 2-ethylhexanoate and 25% of ethylene glycol
¹⁸⁾ Diphenylmethane diisocyanate, NCO content = 31.2% (manufactured by Nippon Polyurethane Industry Co., Ltd., tradename: CORONATE 1130)

Here, measurement of the foam reactivity, evaluation of the foam moldability, measurement of the foam density and judgment of the foam odor were carried out as follows.

### Measurement of Foam Reactivity

Cream time: This is a foaming initiation time, and the time when the mixed liquid started foaming was visually measured.

Gel time: This is a resin-forming time, and a slender rod was thrusted into an expanded foam and withdrawn, whereby the time until a cobwebbing phenomenon took place, was measured.

Rise time: The time until the rising of an expanded foam terminated, was visually measured.

### Moldability of Foam

The appearance and the state of cells of the obtained foam were observed, whereby the moldability was evaluated as follows.

◯: The surface state of the foam is smooth, and the foam cells are fine.

Δ: Certain irregularities are observed on the surface of the foam, but the foam cells are fine.

×: Irregularities are observed on the surface of the foam, and the foam cells are also large.

### Measurement of the Foam Density

A center portion of the foam expanded in a 2 L polyethylene cup was cut into a size of 6 cm×6 cm×10 cm, and the size and weight were accurately measured, whereupon the foam density (kg/m³) was calculated.

### Judgment of Foam Odor

The foam cut for the measurement of the foam density was put and sealed in a polyethylene bag, and the odor in the polyethylene bag was smelled by three monitors, and the odor intensity was evaluated as divided into three grades.

◯: No substantial odor from the foam is smelled.

Δ: An odor from the foam is smelled.

×: An odor from the foam is strong.

As is evident from Table 7, in Examples (Examples 19 to 25) for producing rigid polyurethane foams by using the amine carbonates obtained in Preparation Examples 4 to 6, the cream time as the foaming initiation time was fast, and the initial foaming property was excellent in spite of the fact that the liquid temperatures of the premix liquid and the polyisocyanate were as low as 5° C.

On the other hand, Comparative Examples 28 to 30 are examples wherein, as the catalyst, catalyst 3A [N,N,N′-trimethylaminoethylethanolamine (manufactured by TOSOH CORPORATION, tradename: TOYOCAT-RX5)] and catalyst 3E [lead 2-ethylhexanoate (manufactured by Nihon Kagaku Sangyo Co., Ltd., tradename: NIKKA OCTHIX)] being a heavy metal catalyst, were used without using the amine carbonate obtained in Preparation Example, wherein the cream time was slow, and it is understood that it becomes necessary to add a large amount of the amine catalyst in order to obtain the cream time equivalent to Examples of the present invention.

Further, Comparative Examples 31 to 33 are examples wherein as the catalyst, catalyst 3A and catalyst 3H (potassium 2-ethylhexanoate) used in Examples 19 to 25 were used without using the amine carbonates obtained in Preparation Examples, wherein the cream time was slow, and it is understood that it becomes necessary to add a large amount of the amine catalyst in order to obtain the cream time equal to Examples of the present invention.

Further, Examples 26 to 28 are examples wherein instead of catalyst 3H, catalyst 3B [bismuth neodecanoate (manufactured by Shepherd Chemical, tradename: BICAT-H)], catalyst 3C [zinc neodecanoate (manufactured by Shepherd Chemical, tradename: BICAT-Z)] and catalyst 3D [quaternary ammonium salt catalyst (manufactured by TOSOH CORPORATION, tradename: TOYOCAT-TRX)] were, respectively, used, wherein the cream time was fast in the same manner as in Examples 19 to 25.

On the other hand, Comparative Example 34 is an example wherein instead of catalyst 3A, catalyst 3F [N,N,N′,N″,N″-pentamethyldiethylenetriamine (manufactured by TOSOH CORPORATION, tradename: TOYOCAT-DT)] was used without using the amine carbonates obtained in Preparation Examples, wherein improvement of the cream time was inadequate, and the odor of the foam was strong.

Further, Comparative Example 35 is an example wherein N-methylethanolamine carbonate obtained in Preparation Example 6, was used, wherein improvement of the cream time was inadequate as compared with Examples of the present invention.

From these results, it is evident that by using the foaming additive of the present invention, it is possible to produce a rigid polyurethane foam in a fast foaming initiation time without polluting the environment.

### <Production of Spray Type Rigid Polyurethane Foam>

### Examples 29 and 30 and Comparative Examples 36 and 37

In a raw material blend ratio shown in Table 8, about 15 kg of each of premixes in Examples 29 and 30 and Comparative Examples 36 and 37 was formulated, thoroughly mixed and set in a spray machine. Likewise, the polyisocyanate shown in Table 8 was set in a spray machine, and then, the spray machine foaming was carried out under the following foaming conditions. The reactivity during the foaming was measured with respect to the mixed liquid ejected for about 0.5 second from the spray gun to a slate (30×30 cm) adjusted to a surface temperature of 0° C. With respect to the comparison of the core density of the foam and the moldability of the foam, a foam layer having a thickness of about 50 mm was molded on a slate (30×30 cm), measured and compared. The results are shown also in Table 8.

TABLE 8

| | | | | Comparative | |
|---|---|---|---|---|---|
| | | Examples | | Examples | |
| | | 29 | 30 | 36 | 37 |
| Foaming | Polyol 3A¹⁾ | 50 | 50 | 50 | 50 |
| formulation | Polyol 3B²⁾ | 50 | 50 | 50 | 50 |
| (parts by weight) | Foam stabilizer³⁾ | 1.8 | 1.8 | 1.8 | 1.8 |
| | Foam stabilizer⁴⁾ | 0.3 | 0.3 | 0.3 | 0.3 |
| | Flame retardant⁵⁾ | 20 | 20 | 20 | 20 |
| | Amine carbonate⁶⁾ | 3C-1 | 3C-3 | — | — |
| | (added amount) | 5.1 | 7.5 | | |
| | Added amount of⁷⁾ | 2.4 | 1.2 | 4.5 | 4.5 |
| | water | (4.5) | (4.5) | | |
| | (total amount of | | | | |
| | water) | | | | |
| | Viscosity-reducing⁸⁾ | 5 | 5 | 5 | 5 |
| | agent | | | | |
| | Catalyst 3A⁹⁾ | 4.0 | 4.4 | 5.0 | 4.5 |
| | Catalyst 3B¹⁰⁾ | — | — | — | 0.3 |
| | Catalyst 3C¹¹⁾ | 3.0 | 3.0 | 3.0 | — |
| | Polyisocyanate¹²⁾ | Premix/Polyisocyanate = | | | |
| | | 1/1 (volume ratio) | | | |
| Foam reactivity | Cream time (sec) | 1.7 | 1.5 | 5.1 | 1.5 |
| | Rise time (sec) | 7 | 6 | 15 | 5 |

| | | | | |
|---|---|---|---|---|
| Form density (kg/m³) | 28.6 | 28.4 | 28.5 | 29.4 |
| Moldability | ◯ | ◯ | Δ | ◯ |

¹⁾Terephthalic acid type polyester polyol, Terol-1254, OHV = 258 mgKOH/g (manufactured by Oxid)
²⁾Mannich type polyol DK3810 OHV-314 mgKOH/g (manufactured by Dai-ichi Kogyo Seiyaku Co., Ltd.)
³⁾Silicone type surfactant, L6188 (manufactured by Momentive)
⁴⁾Silicone type surfactant, L6900 (manufactured by Momentive)
⁵⁾Tris(chloropropyl) phosphate (manufactured by Daihachi Chemical Industry Co., Ltd., tradename: TMCPP)
⁶⁾Polyoxyalkylenediamine carbonate shown in Table 6
⁷⁾Amount of water added, and in ( ), total amount of water having the amount of water in the amine carbonate added.
⁸⁾Propylene carbonate (reagent)
⁹⁾N,N,N′-trimethylaminoethylethanolamine (manufactured by TOSOH CORPORATION, tradename: TOYOCAT-RX5)
¹⁰⁾Lead 2-ethylhexanoate, lead concentration: 20% (manufactured by Nihon Kagaku Sangyo Co., Ltd., tradename: NIKKA OCTHIX)
¹¹⁾Mixture of 75% of potassium 2-ethylhexanoate and 25% of ethylene glycol
¹²⁾Diphenylmethane diisocyanate, NCO content = 31.2% (manufactured by Nippon Polyurethane Industry Co., Ltd., tradename: CORONATE 1130)

Here, the foaming conditions, measurement of the reactivity and evaluation of the moldability of the foam were as follows.

### Foaming Conditions

Spray machine: Manufactured by GUSMER, tradename: H-2000

Mixing ratio: Premix/isocyanate=1/1 (volume ratio)

Raw material liquid temperature: 40±1° C.

Spray substrate: Slate (30×30 cm)

Surface temperature of substrate: 0° C.

### Measurement of Reactivity

Cream time: The time when rising of a foam started was measured by means of a stopwatch.

Rise time: The time when rising of the foam terminated, was measured by means of a stopwatch.

### Moldability of Foam

The appearance of a foam molded on the slate was visually observed, and the moldability was evaluated as follows.

◯: The surface of the foam is flat,

Δ: Slight irregularities are observed on the surface of the foam.

×: Many irregularities are observed on the surface of the foam.

### Core Density of Foam

A center portion of the foam molded on the slate was cut into a size of 200×200×30 mm, and the size and weight were accurately measured, whereupon the core density was calculated.

Examples 29 and 30 are examples for producing a spray type rigid polyurethane foams by using the amine carbonates obtained in Preparation Examples 4 and 6, respectively. It is evident that also in the foaming by means of the spray machine, the cream time as the foaming initiation time was fast and the initial foaming property was excellent.

On the other hand, Comparative Example 36 is an example wherein catalyst 3A (potassium 2-ethylhexanoate) and catalyst 3C (N,N,N′-trimethylaminoethylethanolamine) used in Examples 11 and 12, were used, wherein the cream time was slow as compared with Examples of the present invention.

Further, Comparative Example 37 is a conventional example wherein lead 2-ethylhexanoate being a heavy metal catalyst was used.

### INDUSTRIAL APPLICABILITY

The present invention is useful for a foaming additive for producing a polyurethane foam and for the production of a rigid polyurethane foam by using it.

The entire disclosures of Japanese Patent Application No. 2009-106225 filed on Apr. 24, 2009, Japanese Patent Application No. 2009-171447 filed on Jul. 22, 2009 and Japanese Patent Application No. 2009-184686 filed on Aug. 7, 2009 including specifications, claims and summaries are incorporated herein by reference in their entireties.

1. A foaming additive for producing a polyurethane foam, which comprises a salt of carbon dioxide with an amine compound of one or more types selected from the group consisting of an amine compound (I) represented by the following formula (1): 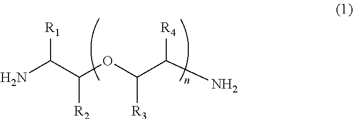
wherein each of R₁ to R₄ which are independent of one another, is a hydrogen atom or a methyl group, and n is a number of at least 1, an amine compound (II) represented by the following formula (2): 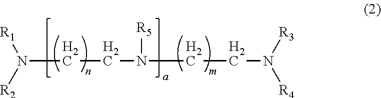
wherein each of R₁ to R₄ which are independent of one another, is a hydrogen atom or a C₁₋₃ alkyl group, R₅ is a hydrogen atom, a C₁₋₃ alkyl group, a C₁₋₃ aminoalkyl group, a C₂₋₄ N-methylaminoalkyl group or a C₃₋₅ N,N-dimethylaminoalkyl group, or R₅ may be optionally bonded to R₁, R₂, R₃ or R₄ to form a cyclic compound having a piperazine structure, provided that at least one of R₁ to R₅ is a hydrogen atom, and all of R₁ to R₅ are not hydrogen atoms, each of n and m which are independent of each other, is an integer of from 1 to 5, and a is an integer of from 1 to 6, an amine compound (III) represented by the following formula (3): 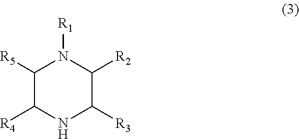
wherein R₁ is a C₁₋₄ alkyl group, and each of R₂ to R₅ which are independent of one another, is a hydrogen atom or a methyl group, an amine compound (IV) represented by the following formula (4): 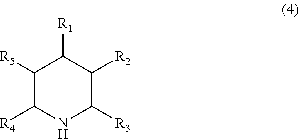
wherein R₁ is a C₁₋₄ alkyl group, and each of R₂ to R₅ which are independent of one another, is a hydrogen atom or a methyl group, and an amine compound (V) represented by the following formula (5): 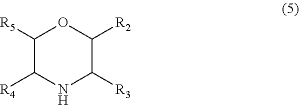
wherein each of R₂ to R₅ which are independent of one another, is a hydrogen atom or a methyl group.

2. The foaming additive according to claim 1, wherein the amine compound (I) is selected from the group consisting of a polyoxypropylenediamine and a polyoxyethylenediamine, having a molecular weight of at least 104.

3. The foaming additive according to claim 1, wherein the amine compound (II) is an N-alkylated derivative of an amine compound selected from the group consisting of diethylenetriamine, dipropylenetriamine, dihexamethylenetriamine, triethylenetetramine, tripropylenetetramine, tetraethylenepentamine, pentaethylenehexamine, N-aminoethylpiperazine, N-2-(2′-aminoethyl)aminoethylpiperazine, N,N′-bis(2-aminoethyl)piperazine, N-2-(2′(2″-aminoethyl)aminoethyl)aminoethylpiperazine, N-2-(2′-aminoethyl)aminoethyl-N′-aminoethylpiperazine, N,N′-bis(3-aminopropyl)piperazine, tris(2-aminoethyl)amine, tris (3-aminopropyl)amine and N,N-bis(2-aminoethyl)diethylenetriamine.

4. The foaming additive according to claim 1, wherein the amine compounds (Ill) to (V) are amine compounds selected from the group consisting of 1-methylpiperazine, 1-ethylpiperazine, 1-propylpiperazine, 1-isopropylpiperazine, 1-butylpiperazine, 1,2-dimethylpiperazine, 1,3-dimethylpiperazine, morpholine, 2-methylmorpholine, 3-methylmorpholine, piperidine, 2-methylpiperidine, 3-methylpiperidine and 4-methylpiperidine.

5. A foaming additive for producing a polyurethane foam, which comprises the salt of carbon dioxide with an amine as defined in claim 1, dissolved in a solvent.

6. The foaming additive according to claim 5, wherein the solvent is water or a mixture of water with an organic solvent.

7. A method for producing a rigid polyurethane foam, which comprises reacting a polyol with a polyisocyanate in the presence of a catalyst and a foaming agent, wherein the catalyst is a catalyst of one or more types selected from the group consisting of a tertiary amine, a quaternary ammonium salt and a carboxylic acid metal salt (provided that salts of lead, tin and mercury are excluded), and a part or whole of the foaming agent is the foaming additive as defined in claim 1.

8. A method for producing a spray type rigid polyurethane foam, which comprises reacting a polyol with a polyisocyanate in the presence of a catalyst and a foaming agent, wherein the catalyst is a catalyst of one or more types selected from the group consisting of a tertiary amine, a quaternary ammonium salt and a carboxylic acid metal salt (provided that salts of lead, tin and mercury are excluded), and a part or whole of the foaming agent is the foaming additive as defined in claim 1.

9. The method according to claim 7, wherein the tertiary amine is selected from the group consisting of N,N-dimethylaminoethanol, N,N,N′-trimethylaminoethylethanolamine, 2-(2-dimethylaminoethoxy)ethanol, N,N,N′-trimethyl-N′-hydroxyethylbisaminoethyl ether, N-(3-dimethylaminopropyl)-N,N-diisopropanolamine, N-(2-hydroxyethyl)-N′-methylpiperazine, N,N-dimethylaminohexanol and 5-dimethylamino-3-methyl-1-pentanol.

10. The method according to claim 7, wherein the quaternary ammonium salt is selected from the group consisting of tetramethylammonium acetate, tetramethylammonium formate, tetraethylammonium acetate, tetraethylammonium formate and tetramethylammonium 2-ethylhexanoate.

11. The method according to claim 7, wherein the carboxylic acid metal salt is selected from the group consisting of a bismuth salt of carboxylic acid, a zinc salt of carboxylic acid and an alkali metal salt of carboxylic acid.

12. The method according to claim 7, wherein only the foaming additive for producing a polyurethane foam, which comprises a salt of carbon dioxide with an amine compound of one or more types selected from the group consisting of an amine compound (I) represented by the following formula (1): 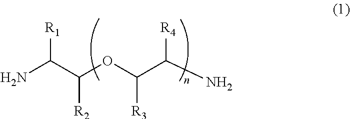
wherein each of R₁ to R₄ which are independent of one another, is a hydrogen atom or a methyl group, and n is a number of at least 1, an amine compound (II) represented by the following formula (2): 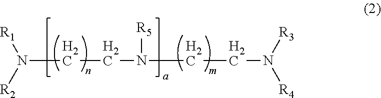
wherein each of R₁ to R₄ which are independent of one another, is a hydrogen atom or a C₁₋₃ alkyl group, R₅ is a hydrogen atom, a C₁₋₃ alkyl group, a C₁₋₃ aminoalkyl group, a C₂₋₄ N-methylaminoalkyl group or a C₃₋₅ N,N-dimethylaminoalkyl group, or R₅ may be optionally bonded to R₁, R₂, R₃ or R₄ to form a cyclic compound having a piperazine structure, provided that at least one of R₁ to R₅ is a hydrogen atom, and all of R₁ to R₅ are not hydrogen atoms, each of n and m which are independent of each other, is an integer of from 1 to 5, and a is an integer of from 1 to 6, an amine compound (III) represented by the following formula (3): 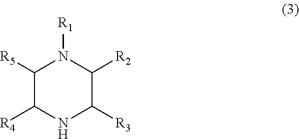
wherein R₁ is a C₁₋₄ alkyl group, and each of R₂ to R₅ which are independent of one another, is a hydrogen atom or a methyl group, an amine compound (IV) represented by the following formula (4): 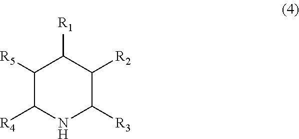
wherein R₁ is a C₁₋₄ alkyl group, and each of R₂ to R₅ which are independent of one another, is a hydrogen atom or a methyl group, and an amine compound (V) represented by the following formula (5): 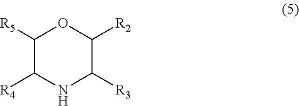
wherein each of R₂ to R₅ which are independent of one another, is a hydrogen atom or a methyl group and water, are used as the foaming agent.
